(19) United States
(12) Patent Application Publication
(10) Pub. No.: US 2006/0155558 A1
(43) Pub. Date: Jul. 13, 2006

(54) System and method of managing mentoring relationships

(75) Inventor: Ingrid Katherine Corpening, Danville, CA (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, L.P.

(21) Appl. No.: 11/033,019

(22) Filed: Jan. 11, 2005

(51) Int. Cl. G06Q 99/00

(52) U.S. Cl. 705/1

(57) ABSTRACT

A method is provided and includes receiving a plurality of completed mentor applications. Further, a plurality of completed protégé applications is received. One of the one of the plurality of completed mentor applications can be matched with one of the plurality of completed protégé applications to create a mentoring relationship. Additionally, an indication to terminate the mentoring relationship can be received. A first termination survey is generated for a mentor associated with the mentoring relationship when the indication to terminate is received. The method further includes generating a second termination survey for a protégé associated with the mentoring relationship. The first termination survey can be communicated to the mentor associated with the mentoring relationship. Also, the second termination survey can be communicated to the protégé associated with the mentoring relationship.

### FIELD OF THE DISCLOSURE

The present disclosure relates generally to the creation and management of mentoring relationships.

### BACKGROUND

Relationships between senior employees and junior employees of the same business are important to career development of the junior employees and the success of the business. Senior employees who have been successful in their employment can teach junior employees how to achieve that same success. Further, as the junior employees mature under the tutelage of the senior employees, the likelihood that the business will remain successful or become more successful increases. Oftentimes, such mentoring relationships are initiated without any particular guidelines or system to facilitate the proper creation and management of the mentoring relationship. For example, a junior employee may need mentoring, but may not know any available mentors. Also, a senior employee that would be a very good mentor in a particular area may never be recognized as such. Additionally, the senior employee may choose to mentor a junior employee that may not be conducive to mentoring.

Accordingly, there is a need for an improved system and method of managing mentoring relationships.

### BRIEF DESCRIPTION OF THE DRAWINGS

The present invention is pointed out with particularity in the appended claims. However, other features are described in the following detailed description in conjunction with the accompanying drawings in which:

FIG. 1 is a general diagram of an exemplary mentoring relationship management system;

FIG. 2 and FIG. 3 is a flow chart to illustrate an exemplary method of managing mentoring relationships;

FIG. 4 is a general diagram representative of an embodiment of a graphical user interface that can be used to access a web based mentoring relationship management tool;

FIG. 5 through FIG. 10 are general diagrams representative of exemplary embodiments of a graphical user interface that can be used to set up an account with a mentoring relationship management server;

FIG. 11 through FIG. 13 are general diagrams representative of exemplary pages of a graphical user interface that can be used to retrieve a forgotten password;

FIG. 14 is a general diagram representative of an exemplary embodiment of a graphical user interface that can be used to access various features of a mentoring relationship management tool;

FIG. 15 is a general diagram representative of an exemplary embodiment of a graphical user interface that can be used to access various reference materials associated with a mentoring relationship management tool;

FIG. 16 through FIG. 24 are general diagrams representative of exemplary embodiments of a graphical user interface that can be used to complete a mentor application;

FIG. 25 through FIG. 30 are general diagrams representative of exemplary embodiments of a graphical user interface that can be used to complete a protégé application;

FIG. 31 through FIG. 32 are general diagrams representative of exemplary embodiments of a graphical user interface that can be used to indicate matches between mentors and protégés;

FIG. 33 through FIG. 38 are general diagrams representative of exemplary embodiments of a graphical user interface that can be used to accept a match with a mentor;

FIG. 39 through FIG. 50 are general diagrams representative of exemplary embodiments of a graphical user interface that can be used to manage mentoring relationships;

FIG. 51 through FIG. 56 are general diagrams representative of exemplary embodiments of a graphical user interface that can be used to terminate a mentoring relationship between a mentor and a protégé;

FIG. 57 is a general diagram representative of an exemplary embodiment of a graphical user interface that can be used to contact a mentoring relationship management server;

FIG. 58 through FIG. 60 are general diagrams representative of exemplary embodiments of a graphical user interface that can be used to change a password;

FIG. 61 through FIG. 65 are general diagrams representative of exemplary embodiments of a graphical user interface that can be used to nominate a mentor;

FIG. 66 through FIG. 73 are general diagrams representative of exemplary embodiments of a graphical user interface that can be used to report information related to mentoring relationships; and

FIG. 74 is a general diagram representative of an exemplary embodiment of a graphical user interface that can be used to indicate that a user has logged off of a mentoring relationship management tool.

### DETAILED DESCRIPTION OF THE DRAWINGS

A method is provided and includes receiving a plurality of completed mentor applications. Further, a plurality of completed protégé applications is received. One of the one of the plurality of completed mentor applications can be matched with one of the plurality of completed protégé applications to create a mentoring relationship. Additionally, an indication to terminate the mentoring relationship can be received. A first termination survey is generated for a mentor associated with the mentoring relationship when the indication to terminate is received.

In a particular embodiment, the method further includes generating a second termination survey for a protégé associated with the mentoring relationship. The first termination survey can be communicated to the mentor associated with the mentoring relationship. Also, the second termination survey can be communicated to the protégé associated with the mentoring relationship.

Further in a particular embodiment, the first termination survey and the second termination survey comprise one or more user selectable root cause statements. The one or more root cause statements can be selected from the group consisting of: “Inability to further commit to timeline/timeframe,” “Increased workload,” “Chemistry of Relationship,” “Change in Mentoring Goals,” “Natural End,” and “Other.”

In a particular embodiment, the method also includes transmitting a follow-up survey to the mentor and to the protégé. In an illustrative embodiment, the follow-up survey includes one or more questions that can be scored by the mentor and the protégé. Also, in a particular embodiment, the method includes generating at least one report based at least partially on the first termination survey, the second termination survey, and the follow-up survey. Particularly, the at least one report can include a tally report, a detail report, or a follow-up survey report.

In a non-limiting, exemplary embodiment, the tally report can include a number of protégé applications submitted within a date range, a number of mentor applications submitted within a date range, a number of mentoring relationships formed within a date range, a number of terminated mentoring relationships within a date range, a number of “natural end” terminated mentoring relationships within a date range, a number of “early terminated” mentoring relationships within a date range, a number of declined protégés within a date range, a total number of established mentoring relationships, a total number of available mentors, a total number of pending protégés, a total number of mentoring tool users, and a total number of site visitors.

Also, in an exemplary, non-limiting embodiment, the detail report can include a list of mentors by name, a list of protégés by name, and a list of mentoring relationships. Also, the follow-up survey report can include an average score received for each of the one or more questions, a total number of surveys received, at least one comment, and a source of the comment. In a particular embodiment, the method also includes selectively modifying a management process in connection with establishment of a future mentoring relationship based at least partially on the at least one report.

Also, in a particular embodiment, the matching mentor application is matched with the matching protégé application based on a first set of criteria. The first criteria of criteria can include at least one of the following: building a team, communicating persuasively, taking a risk, driving change, achieving results through others, and accomplishing results. Further, in a particular embodiment, the matching mentor application is matched with the matching protégé application based on a second set of criteria. The second set of criteria can include at least one of the following: experience, location, title, and department.

In a particular embodiment, the method further includes contacting a protégé associated with a matching protégé application after a match is determined. Additionally, the protégé can be queried as to whether the protégé would like to initiate contact with a mentor associated with a matching mentor application. Moreover, a mentor associated with a matching mentor application can be contacted to determine whether the mentor is willing to form the mentoring relationship with the protégé.

A system for managing mentoring relationships includes a network. At least one mentor computer and at least one protégé computer are coupled to the network. Further, at least one mentoring relationship management server is coupled to the network. Particularly, the mentoring relationship management server includes a reporting module, a mentor-protégé matching module, and a mentoring relationship termination module.

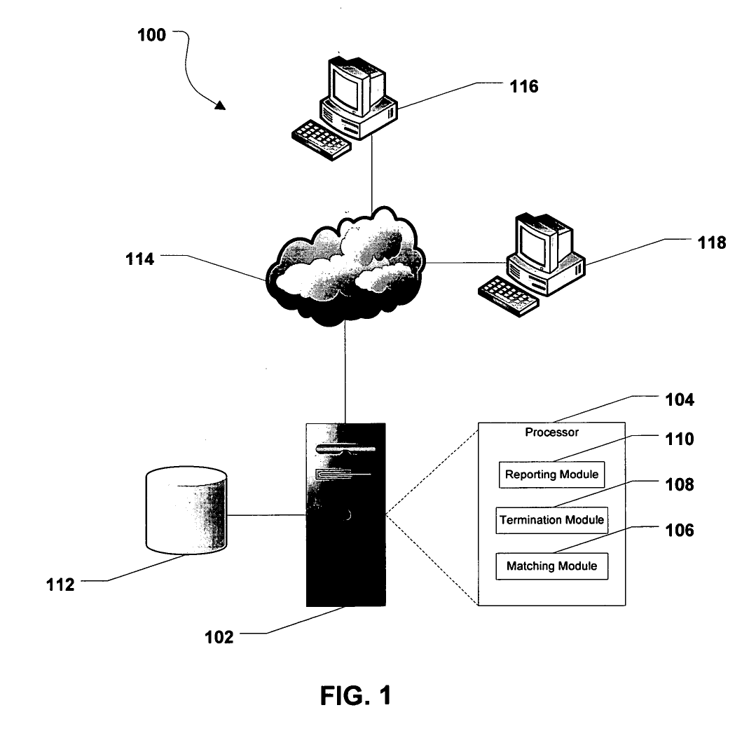

Referring to FIG. 1, an exemplary, non-limiting embodiment of a mentoring relationship management system is illustrated and is generally designated 100. As depicted in FIG. 1, the system includes a mentoring relationship management server 102. In an illustrative embodiment, the mentoring relationship management server 102 is a Cold Fusion server. FIG. 1 indicates that the mentoring relationship management server 102 includes a processor 104 in which a matching module 106, a termination module 108, and a reporting module 110 are embedded. As further shown in FIG. 1, the mentoring relationship management server 102 is coupled to a mentoring relationship management database 112. In a particular embodiment, the mentoring relationship management database 112 includes a plurality of mentor applications, a plurality of protégé applications, and other information relative to the creation and management of mentoring relationships, i.e., relationships between mentors and protégés.

As illustrated in FIG. 1, the mentoring relationship management server 102 is coupled to a network 114, e.g., the Internet. Further, a protégé computer 116 is coupled to the network 114. Also, a mentor computer 118 is coupled to the network 114. In a particular embodiment, the protégé computer 116 can be used by a potential protégé in order to receive a protégé application from the mentoring relationship management server 102, to complete the protégé application, and to transmit, or otherwise communicate, the completed protégé application to the mentoring relationship management server 102. Further, in a particular embodiment, the mentor computer 118, can be used by a potential mentor in order to receive a mentor application from the mentoring relationship management server 102, to complete the mentor application, and to transmit the completed mentor application to the mentoring relationship management server 102.

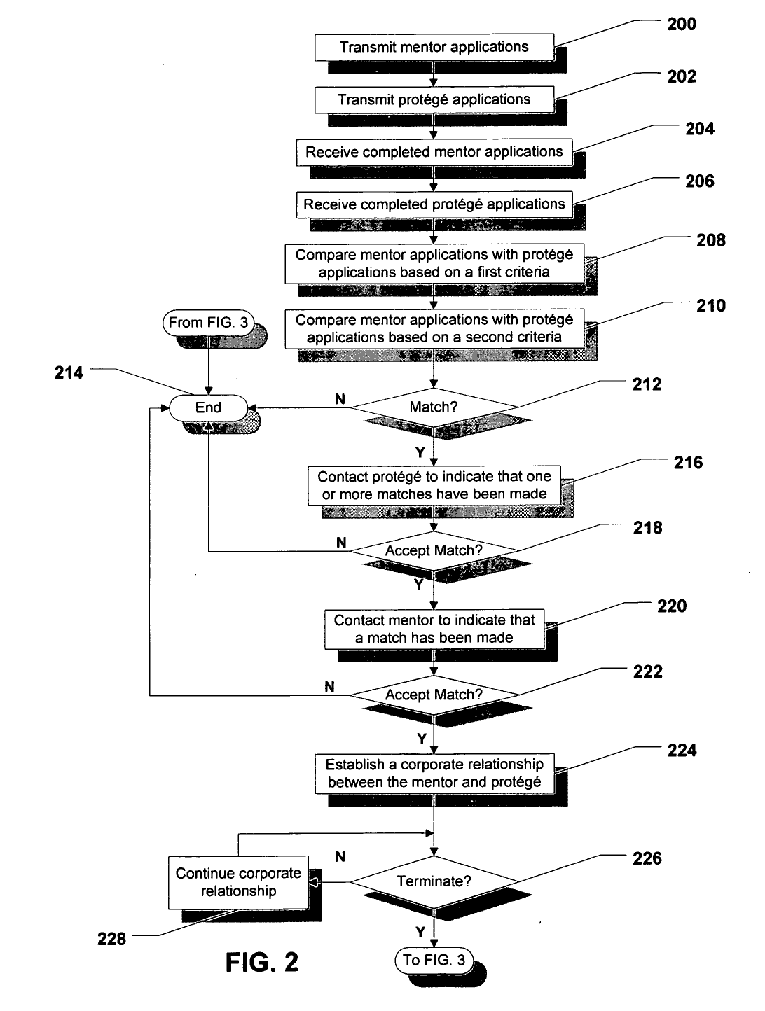

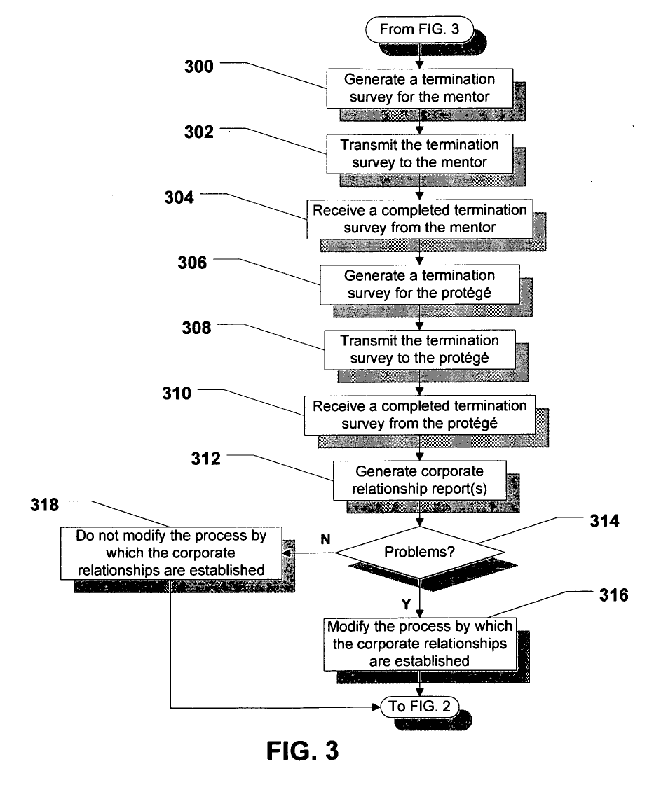

FIG. 2 and FIG. 3 illustrate an exemplary method of managing mentoring relationships. Commencing at block 200, a mentoring relationship management server transmits one or more mentor applications to one or more potential mentors. In a particular embodiment, the mentor applications can be sent at the request of potential mentors. In the alternative, a third party can nominate one or more mentors and then, the mentoring relationship management server can send a mentor application to each nominated mentor.

In a particular embodiment, the mentor application allows a prospective mentor to indicate one or more key areas that the potential mentor could help a junior employee. The key areas can include: building teams, accomplishing results, communicating persuasively, achieving results through others, and driving change. Further, for each key area one or more possible areas for discussion or protégé development are provided. For example, for the key area of building teams, the possible areas for discussion can include: operating as a team player, establishing trust, and effective team development. For the key area of accomplishing results, the possible areas for discussion can include: accomplishing specific results, acting effectively in ambiguous situations, and goal planning. Further, for the key area of communicating persuasively, the areas for discussion can include presenting information effectively, asserting ideas, expressing confidence, negotiating, and persuading. Also, for the key area of risk taking, the possible areas for discussion can include managing risk, making difficult decisions, and learning from failures. For the key area of driving change, the areas for discussion can include generating innovative ideas and solutions, taking initiative, and improving team/self performance.

In a particular embodiment, a potential mentor can select one or more key areas that the potential mentor would like to be considered as a mentor based on the possible areas for discussion that are presented via the mentor application. Further, the potential mentor can indicate a number of protégé requests that the potential mentor would like to review for each key area selected. Additionally, for each key area selected the potential mentor can select one or more key area statements that describe the potential mentor. For example, for the key area of building teams, the potential mentor can select one or more of the following statements: “Develops positive working relationships with other people and team members.”, “Works effectively and respectfully with employees and business partners whose cultures, experiences, and thinking styles are different from their own.”, “Works cooperatively with people in different divisions/departments.”, “Collaborates with others to achieve team results.”, “Values working with others who have different perspectives and backgrounds.”, “Takes ownership for mistakes.”, “Exemplifies honesty and maintains trustworthiness.”, and “Shares own expertise and information with others to accomplish team goals.”

Returning to the description of the method, at block 202, the mentoring relationship management server transmits one or more protégé applications to one or more potential protégés. In an illustrative embodiment, the protégé applications are transmitted in response to requests by potential protégés. Further, in an exemplary, non-limiting embodiment, a protégé application includes the same key areas and possible areas of discussion or protégé development as the mentor application, described above. A potential protégé can select a key area that he or she would like to be a protégé in and then, select one or more key area statements for that key area. At block 204, the mentoring relationship management server receives one or more completed mentor applications from one or more potential mentors. Next, at block 206, the mentoring relationship management server receives one or more completed protégé applications.

Continuing to block 208, the mentoring relationship management server compares one or more mentor applications with one or more protégé applications based on a first set of criteria. In a particular embodiment, the first set of criteria includes one or more goals that can be selected by a potential protégé via a web based mentoring relationship management tool. The goals of the potential protégé can include: building a team, communicating persuasively, taking a risk, driving change, achieving results through others, and accomplishing results. At block 210, the mentoring relationship management server compares the one or more mentor applications to the one or more protégé applications based on a second set of criteria. In an illustrative embodiment, the second set of criteria includes specific compatibility criteria such as experience, location, title, department, etc. Further, in a particular embodiment, a matching module within the mentoring relationship management server can perform the comparisons between the mentor applications and the protégé applications.

Proceeding to decision step 212, the matching module within the mentoring relationship management server can determine whether any matches exist between any mentor applications and any protégé applications. In an illustrative embodiment, a plurality of protégé applications can match a single mentor application. Also, a plurality of mentor applications can match a single protégé application. If no matches exist between the mentor applications and the protégé applications, the method moves to state 214 and ends.

At decision step 212, if any matches exist between the completed mentor applications and the complete protégé applications, the method moves to block 216 and the mentoring relationship management server contacts a potential protégé to indicate that one or more matches have been made between the potential protégé and one or more potential mentors. At decision step 218, the mentoring relationship management server queries the protégé in order to determine whether the protégé wants to accept a match and establish a mentoring relationship between the protégé and a matching mentor. If not, the method ends at state 214.

On the other hand, if the protégé accepts a match, the method moves to block 220 and the mentoring relationship management server contacts the matching mentor in order to indicate that a match has been made between the matching mentor and a protégé. Thereafter, at decision step 222, the mentoring relationship management server queries the mentor to determine whether the mentor desires to establish a mentoring relationship with the matching protégé. If not, the method ends at state 214. On the other hand, if the mentor does wish to establish a mentoring relationship with the matching protégé, the method proceeds to block 224 and the mentoring relationship management server establishes a mentoring relationship between the mentor and the protégé.

In a particular embodiment, the mentoring relationship management server can send the matching results to the protégé in table form. The matching results table can include the name of each matching mentor, the title of each matching mentor, the organization of each matching mentor, the location of each matching mentor, the telephone number of each matching mentor, and the user identification number of each matching mentor. Further, the matching results table can provide the key area statements submitted by each potential mentor. The protégé can use the information provided by the results table in order to decide whether or not to initiate a mentoring relationship with any of the potential mentors in the results table.

After the mentoring relationship is established, the relationship is monitored and managed by the system. Moving to decision step 226, the mentoring relationship management server determines whether the mentor or the protégé has sent a request to terminate the mentoring relationship. If no such request is received, the method moves to block 228 and the mentoring relationship continues. On the other hand, if a request to terminate the mentoring relationship is received from the mentor or the protégé, the method continues to block 300 of FIG. 3.

At block 300 of FIG. 3, during termination, the mentoring relationship management server generates a termination survey for the mentor. At block 302, the mentoring relationship management server transmits the termination survey to the mentor. Moving to block 304, the mentoring relationship management server receives a completed termination survey from the mentor. At block 306, the mentoring relationship management server generates a termination survey for the protégé. Next, at block 308, the mentoring relationship management server transmits the termination survey to the protégé. Proceeding to block 310, the mentoring relationship management server receives a completed termination survey from the protégé.

In a particular embodiment, a termination module within the mentoring relationship management server generates the termination surveys, transmits the termination surveys; and receives the completed surveys from the mentors and protégés. Further, in an illustrative embodiment, each termination survey includes information confirming the mentoring relationship and information related to the cause of the termination. Particularly, the termination survey can include one or root cause statements that can be user selected. The root cause statements can include one or more of the following: “Inability to further commit to timeline/timeframe,” “Increased workload,” “Chemistry of Relationship,” “Change in Mentoring Goals,” “Natural End,” or “Other.” For each statement, a user can input confidential comments related to the root cause statement that can be used to further assess the cause of the termination. The termination survey can also include a text input box in which a user can type a short statement to be added to an auto-generated email informing the other party that the mentoring relationship has been terminated.

In an alternative embodiment, a follow-up survey can be submitted to each mentor and protégé that was part of a terminated mentoring relationship after a predetermined time period. Each mentor or protégé is given a chance to assess the entire process related to the mentoring relationship. For example, a mentor or protégé is given a chance to score a group of statements. Each statement can be given the following scores: 1=Strongly Disagree, 2=Disagree, 3=Neutral, 4=Agree, and 5=Strongly Agree. The statements can include the following:
1. The mentoring program was well advertised.
2. It was easy to get into the mentoring program.
3. The initial information packet was helpful in setting up our mentoring relationship.
4. I am glad there was an initial kickoff meeting to the mentoring program.
5. The matching process for mentor/protégé pairs was very helpful.
6. I did not receive accurate instruction on the processes that needed to be followed in the program.
7. I think the length of the mentoring program is sufficient.
8. The mentoring agenda document was helpful in keeping our meetings on track.
9. The mentoring meeting agenda document was helpful in keeping our meetings on track.
10. Using the leadership enhancement plan as a way to determine the protégé's goals and objectives worked well.
11. Having a quarterly review of our progress did not add a lot of value to the program.
12. The quarterly review document was a good tool for completing the quarterly review.
13. Having my supervisor aware of my participation in the mentoring program was helpful.
14. The documentation provided to facilitate the termination of the mentoring relationship is adequate.
15. Overall I was pleased with the structure of the mentoring program.
16. I continue to maintain a professional relationship with my mentor/protégé.
17. The skills I learned in the mentoring program have continued to help me in my career.
18. I would consider being a mentor/protégé again.

Continuing to block 312, the mentoring relationship management server generates one or more mentoring relationship reports. In an illustrative embodiment, a report module within the mentoring relationship management server generates one or more mentoring relationship reports. In an illustrative embodiment, several reports can be generated. For example, a tally report, a detail report, and a follow-up survey report can be provided. In an illustrative embodiment, the tally report can include a number of protégé applications submitted within a date range, a number of mentor applications submitted within a date range, a number of relationships formed within a date range, a number of terminated relationships within a date range (all types), a number of “natural end” terminated pairs within a date range, a number of “early terminated” relationships within a date range, a number of protégés who were declined within a date range, a total number of formed relationships, a total number of available mentors, a total number of protégés in pending status, a total number of tool users, and a total number of site visitors.

Further, in an illustrative embodiment, the detail report can include a list of mentors by name (all or within a date range), a list of protégés by name (all or within a date range, and the details of mentoring relationships (all or within a date range). Also, the follow-up survey report can include an average score received for each survey question (for the entire time the question has been asked for a particular date range), a total number of surveys received (e.g., a grand total or a total number for a date range), and the text of any comments and the source of the comments (either mentor or protégé.)

Moving to decision step 314, the mentoring relationship management server determines whether the one or more mentoring relationship reports indicate one or more problems associated with the process by which mentoring relationships are established. If the mentoring relationship reports indicate one or more problems, the method proceeds to block 316 and the mentoring relationship reports generated by the mentoring relationship management server can be used to modify the process by which future mentoring relationships are established and managed. In a particular embodiment, modification of the process can be driven by a human manager.

In the alternative, the mentoring relationship management server can monitor one or more parameters presented within the mentoring relationship reports and automatically adjust the mentoring relationship creation and termination process in order to maintain the parameter within a predefined range. For example, the mentoring relationship server can monitor the number of mentoring relationships that are created over a time period and if that number is lower than a predetermined threshold, then the mentoring relationship server can send unsolicited mentor applications to previously approved mentors. From block 316, the method returns to FIG. 2 and the method ends at state 214. On the other hand, at decision step 314, if the mentoring relationship reports do not indicate one or more problems, the method proceeds to block 318 and the mentoring relationship management server does not modify the process by which the mentoring relationships are established. The method then returns to FIG. 2 and the method ends at state 214.

In an illustrative embodiment, a graphical user interface (GUI) associated with the method described above is provided and is written in hypertext markup language (HTML). A software application, e.g., Cold Fusion, can be used to link the web pages represented by the GUI to the mentoring relationship management database. The GUI enables potential protégé and mentor candidates to provide detailed information about themselves via web based forms or applications. Further, the GUI can provide web based communication during the duration of mentoring relationships between mentors and protégés. Also, the GUI facilitates the termination of the mentoring relationships.

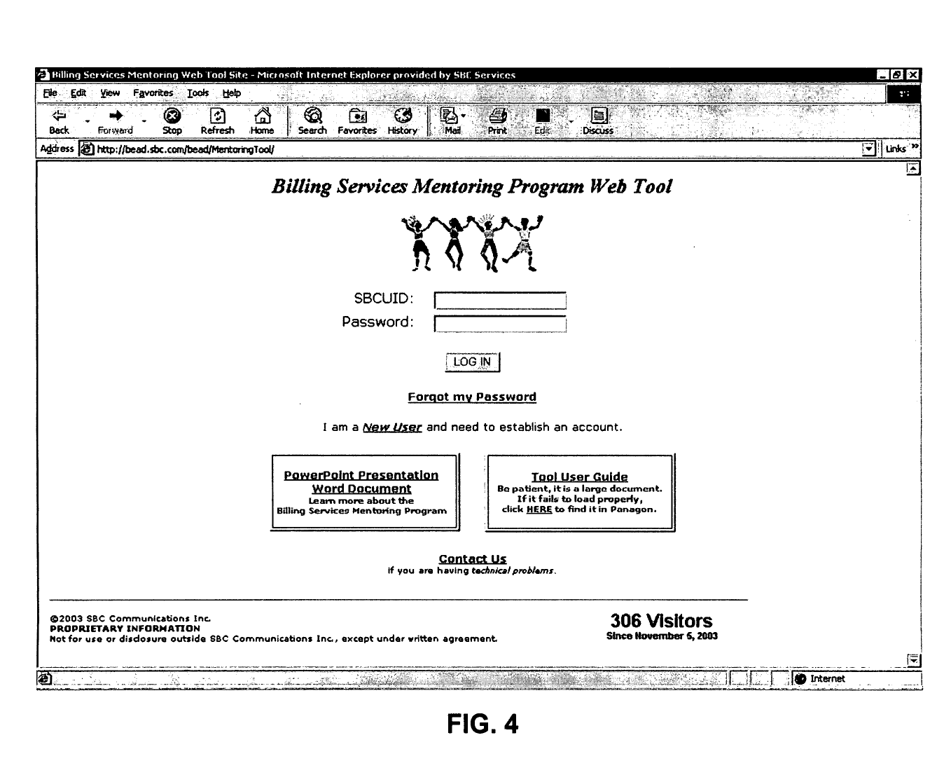

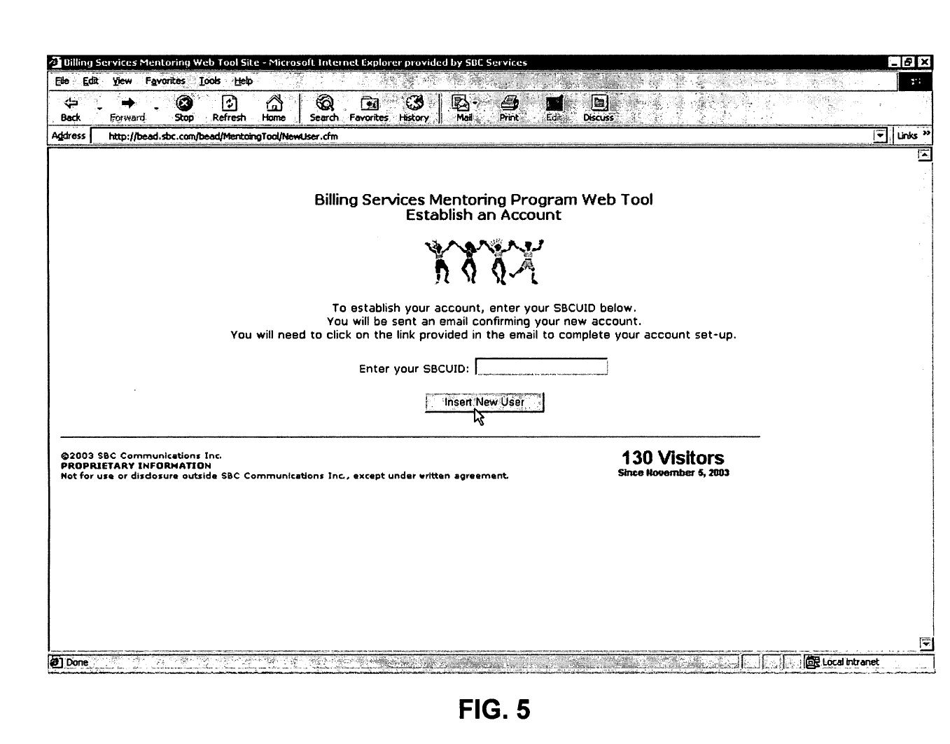

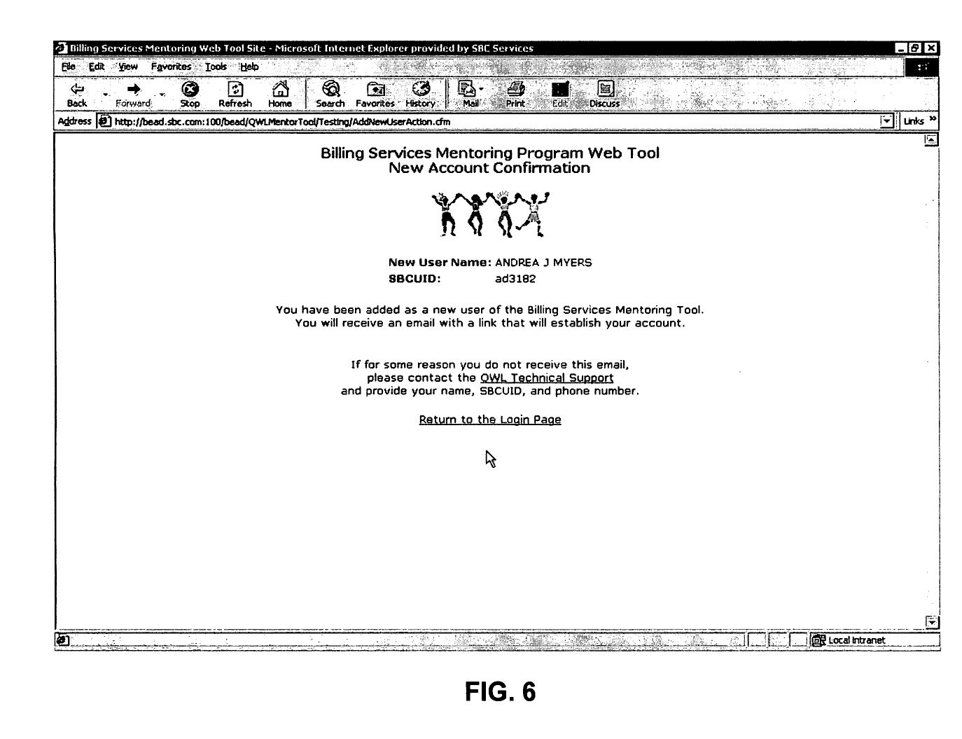

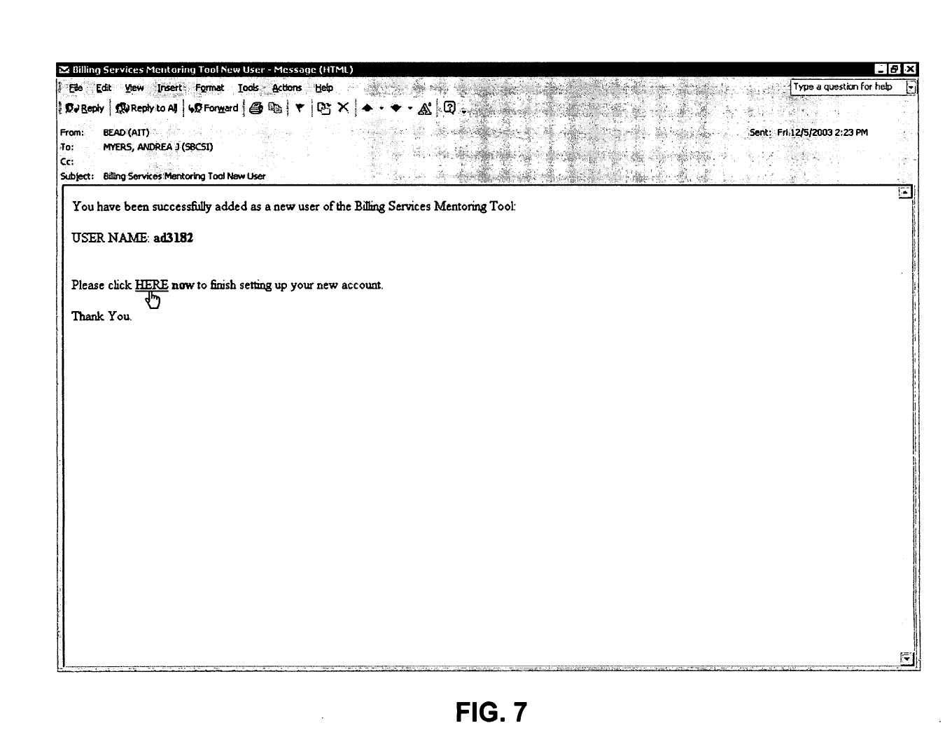

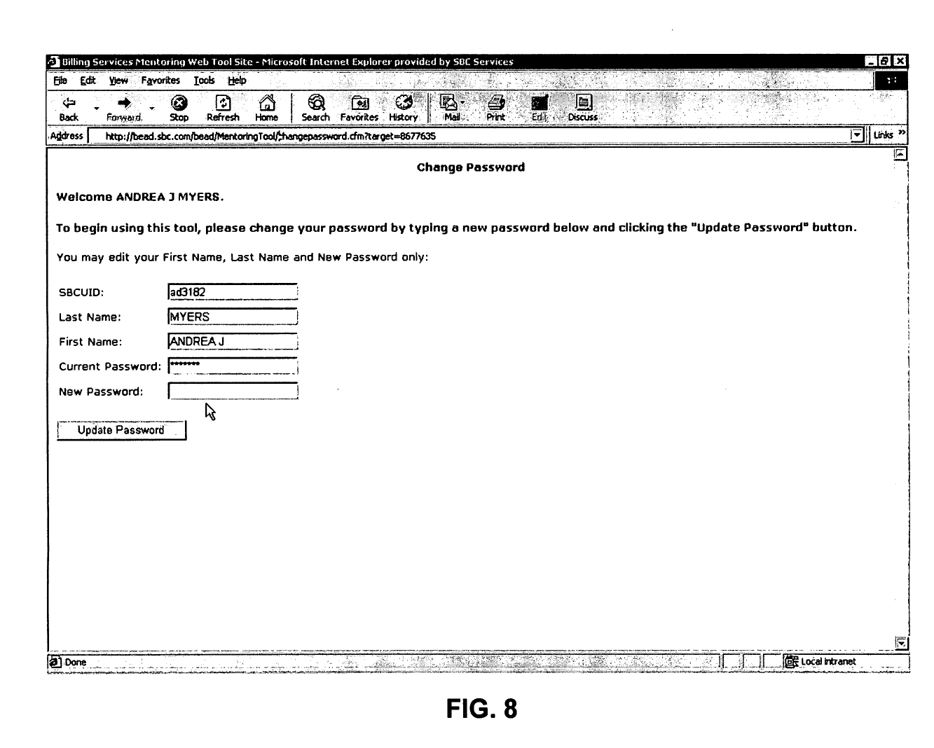

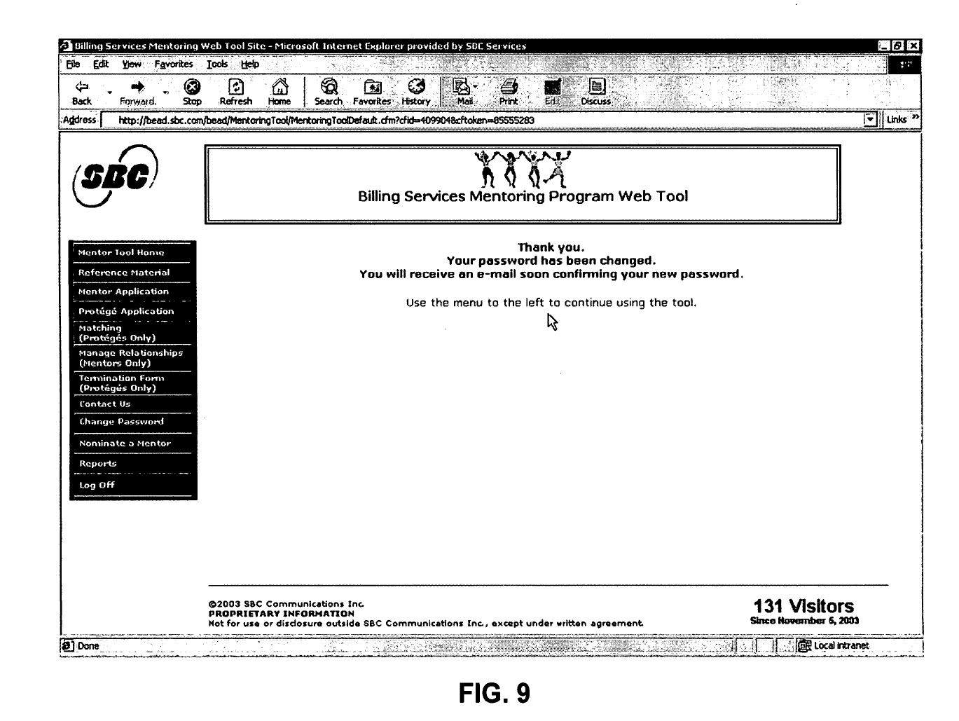

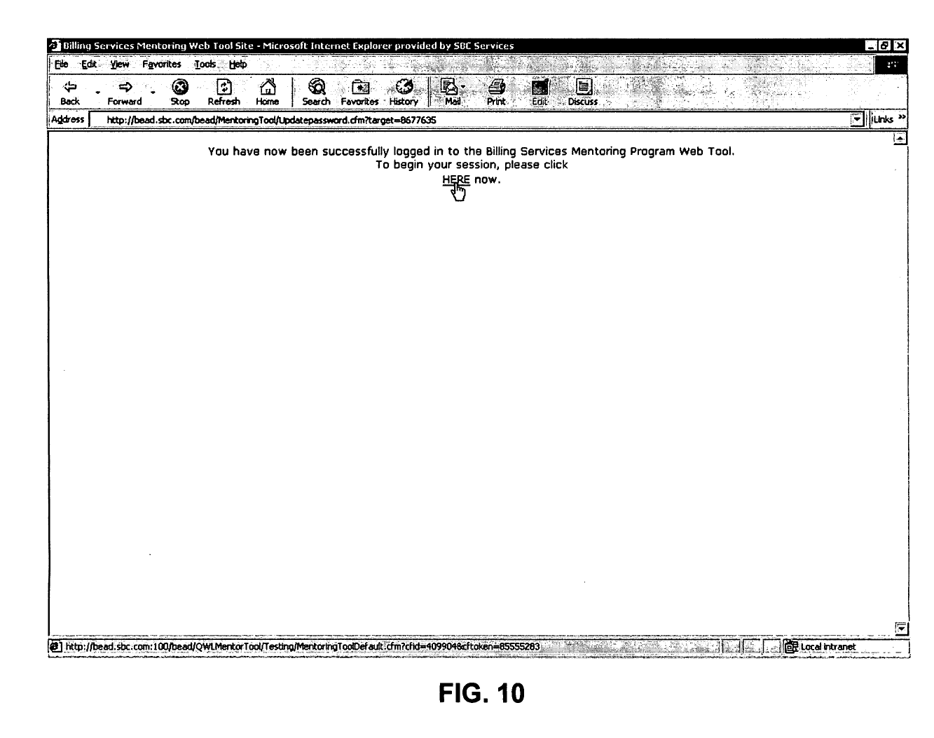

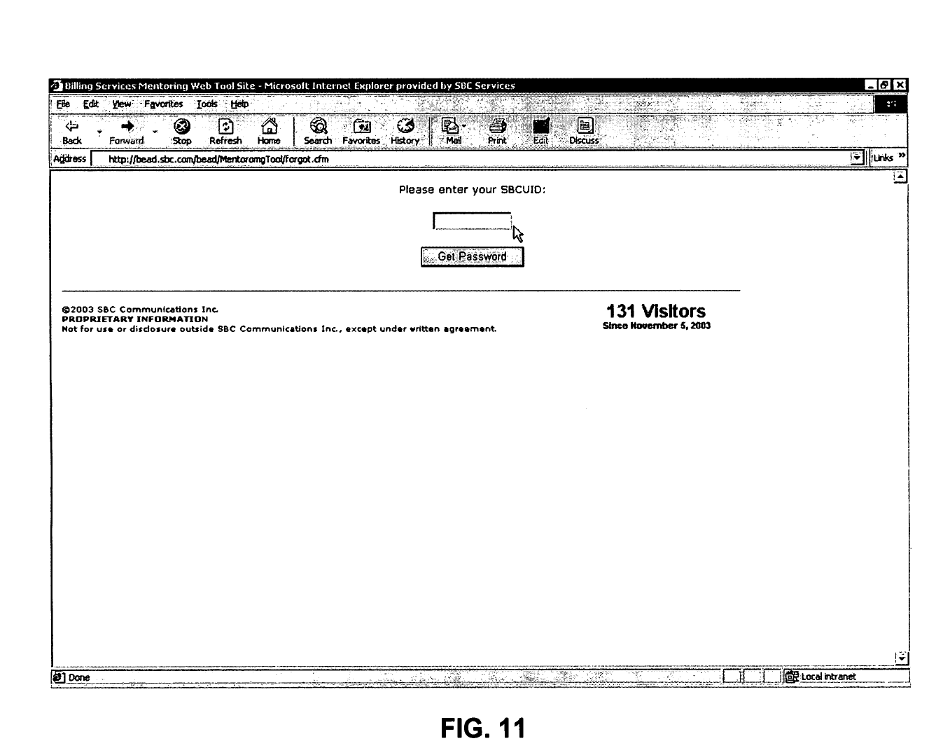

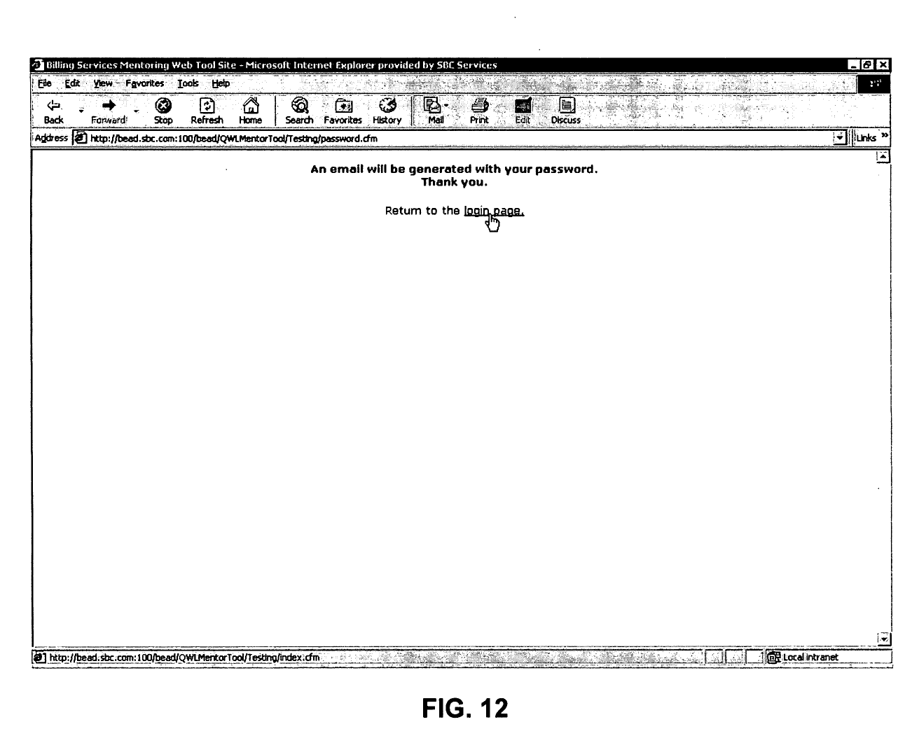

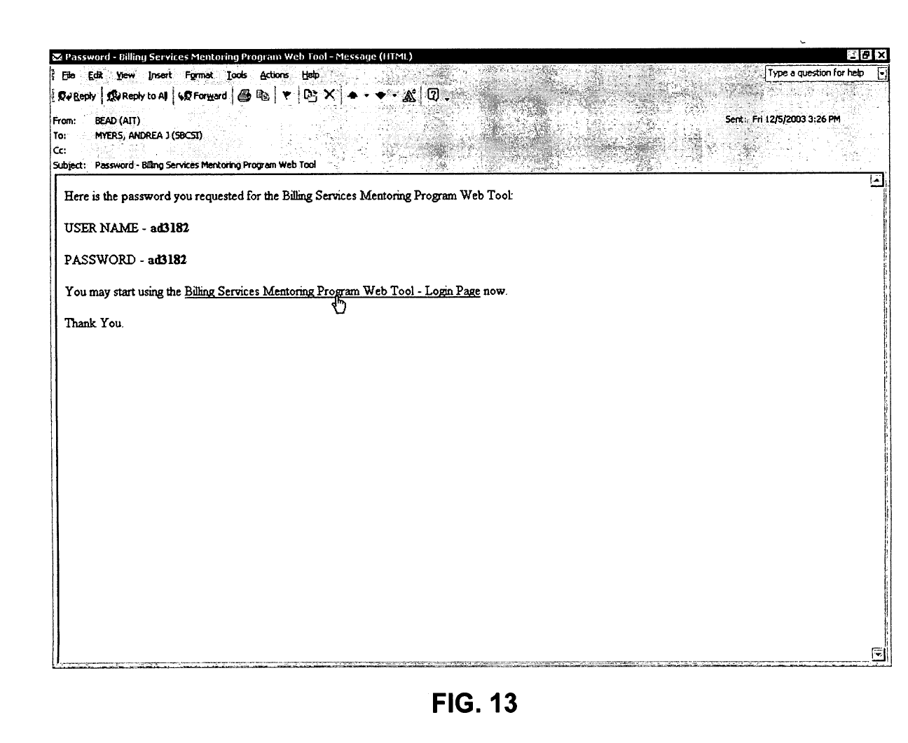

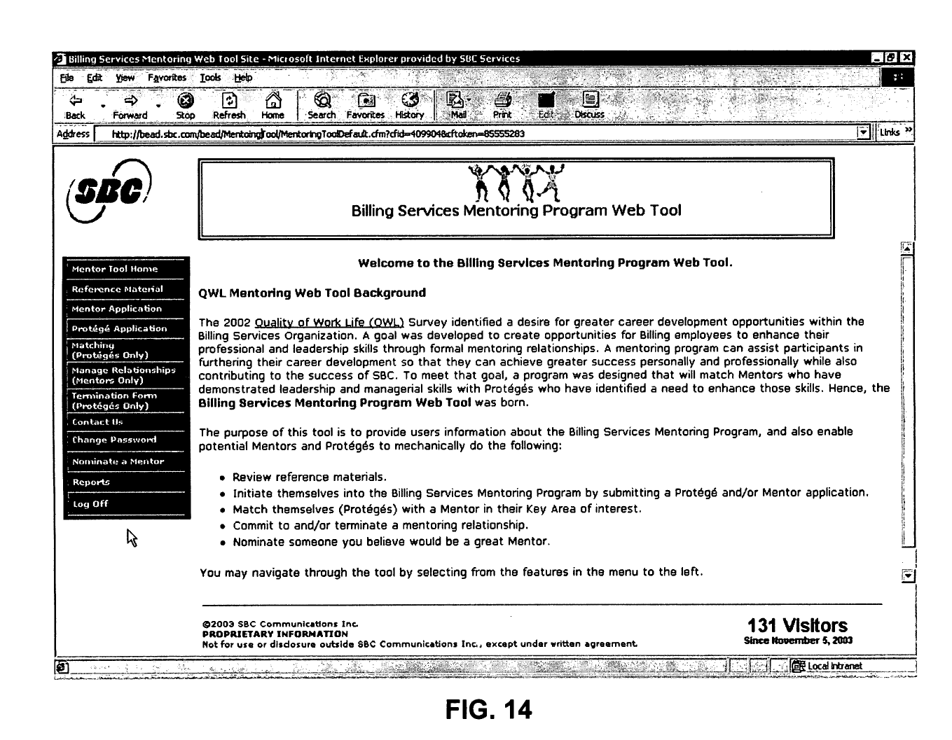

Referring to FIG. 4, an embodiment of a GUI is shown and can be used to access a web based mentoring relationship management tool. FIG. 5 through FIG. 10 depict exemplary embodiments of a GUI that can be used to set up an account with a mentoring relationship management server. FIG. 11 through FIG. 13 illustrate exemplary embodiments of a GUI that can be used to retrieve a forgotten password. FIG. 14 illustrates an exemplary embodiment of a GUI that can be used to access various features of a mentoring relationship management tool. Particularly, FIG. 14 is a home page for a web based mentoring relationship management tool.

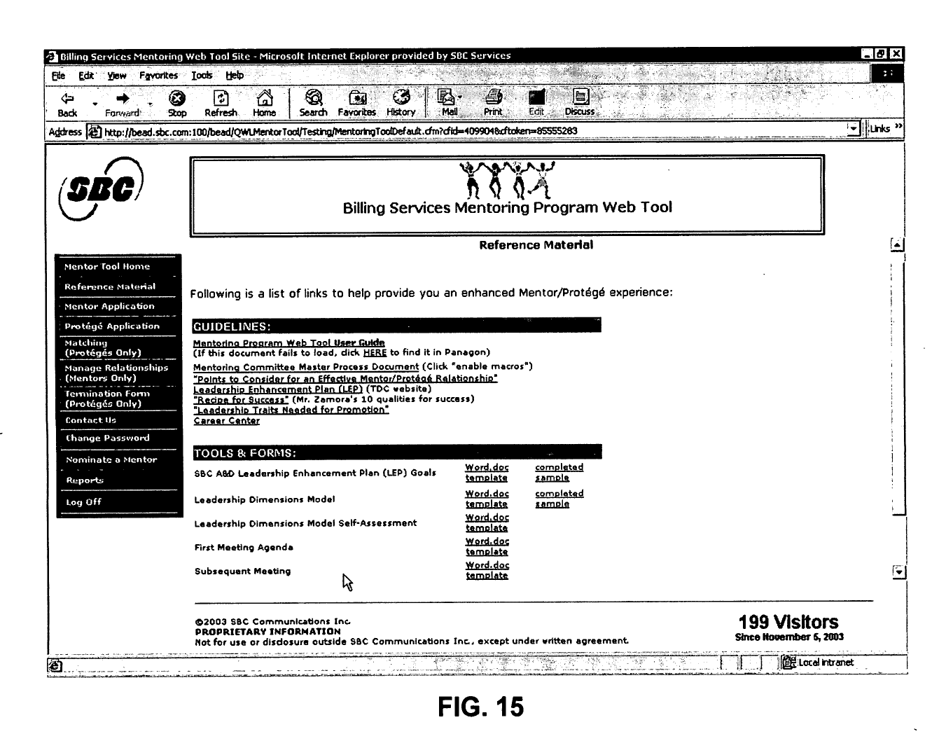

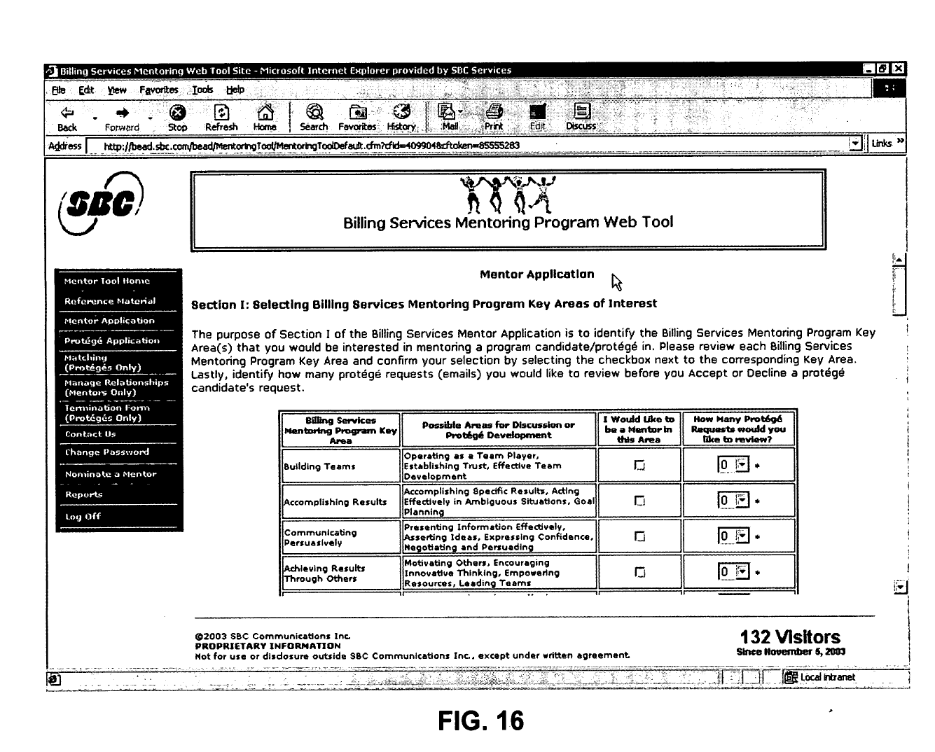

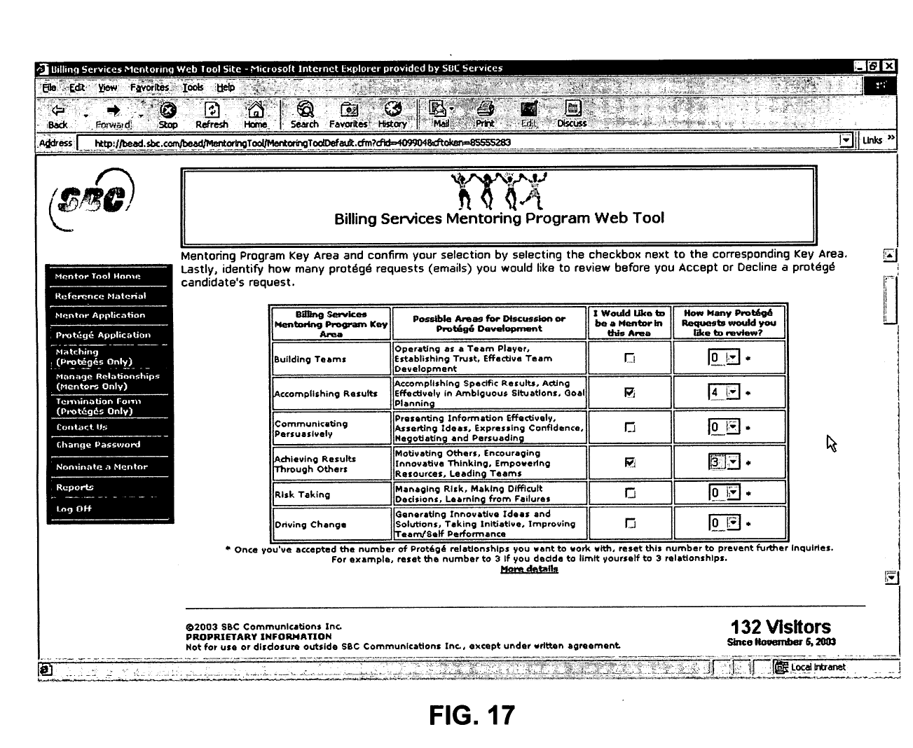

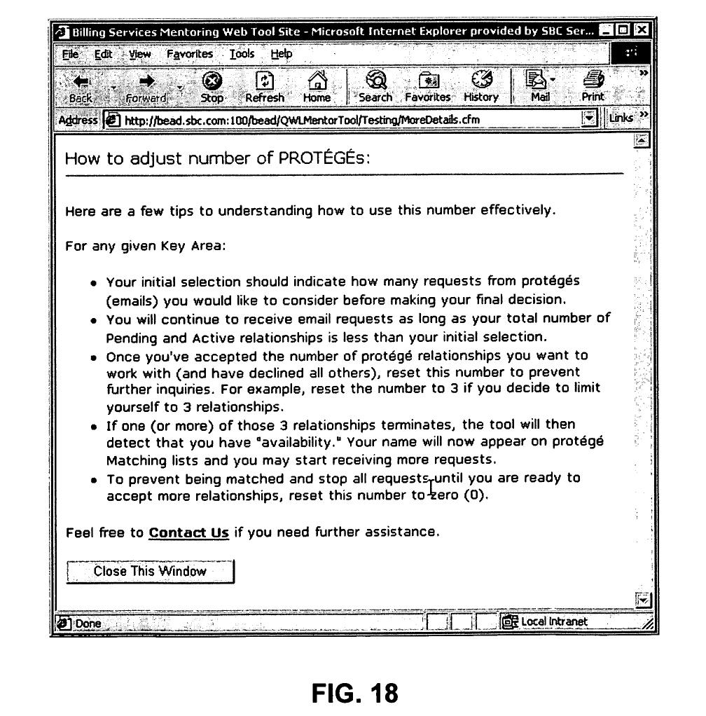

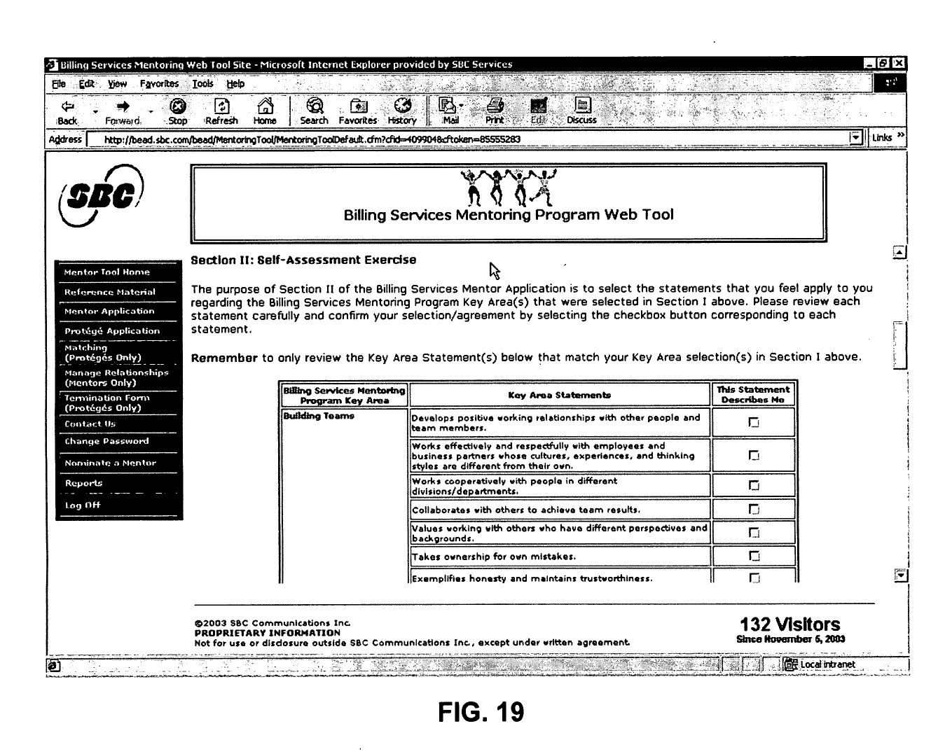

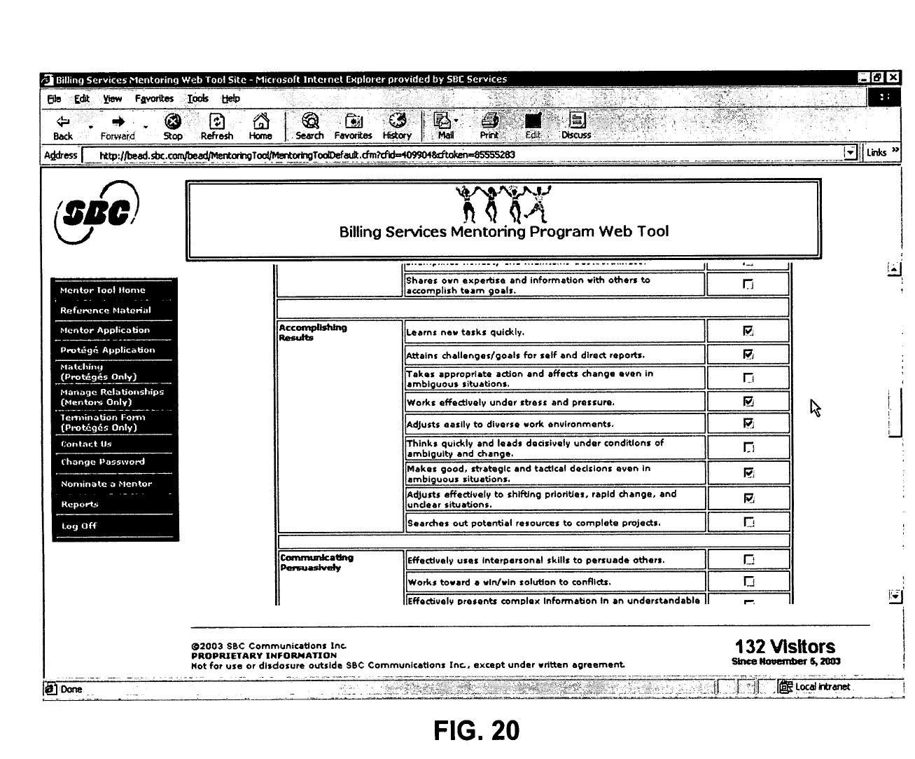

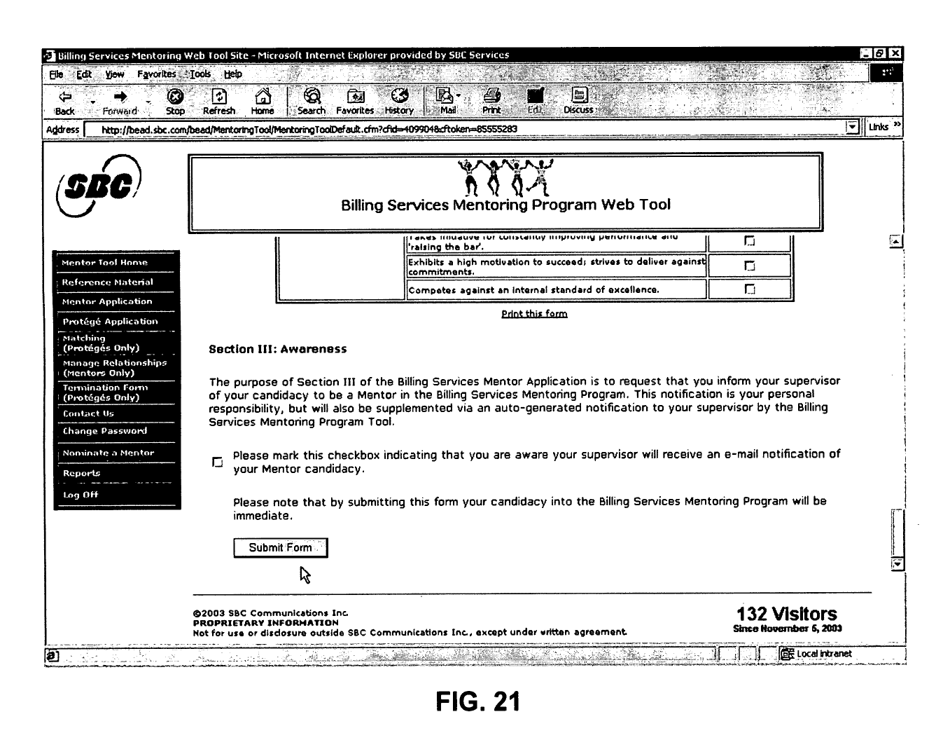

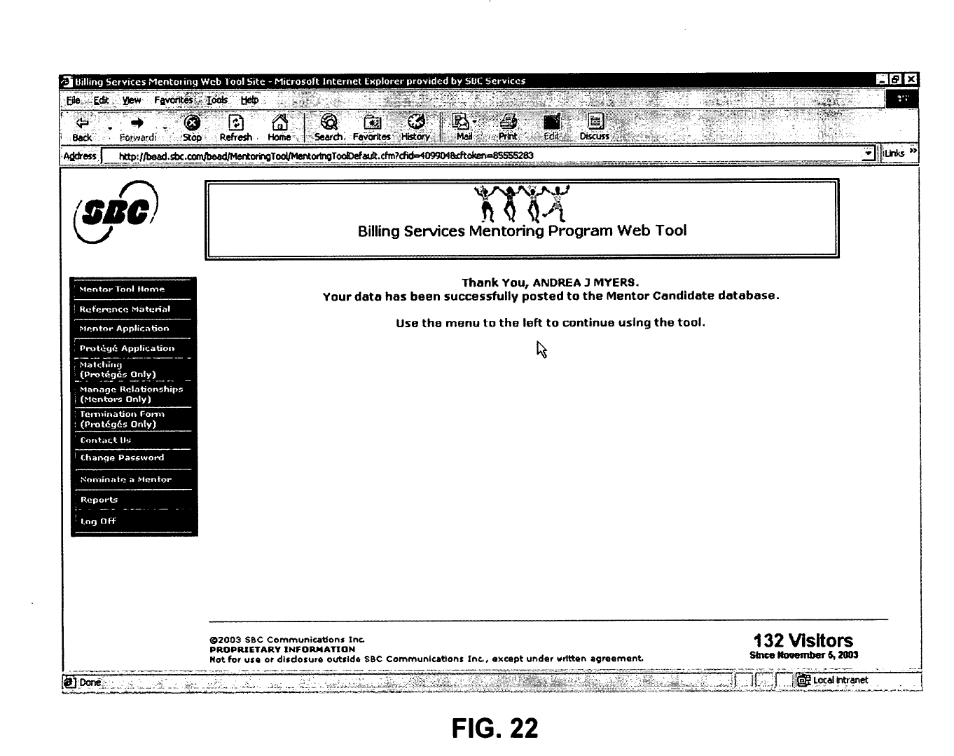

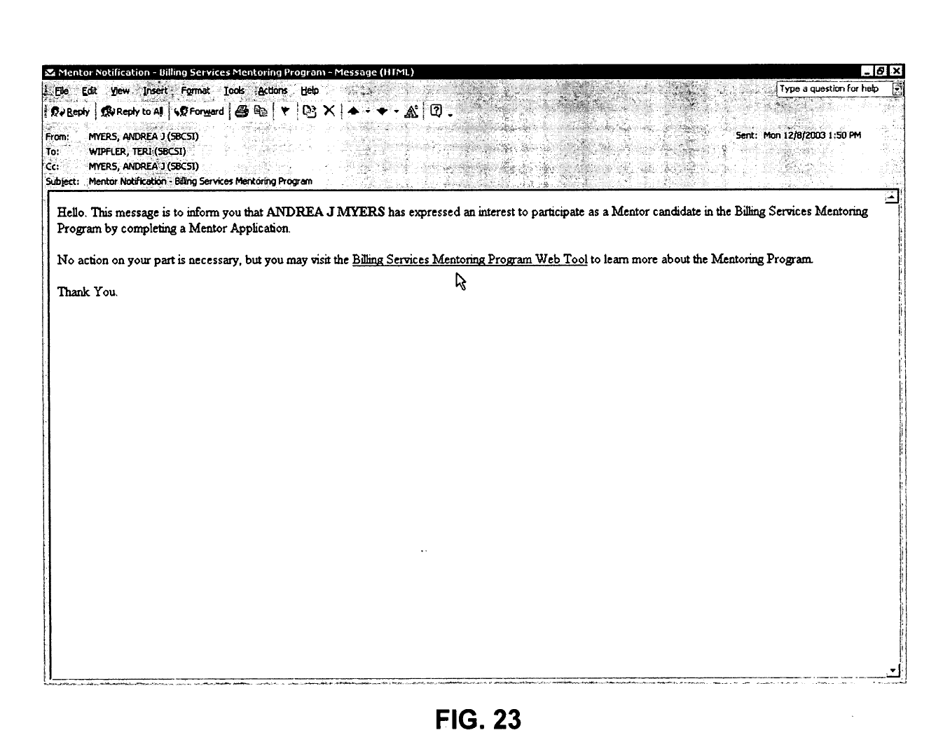

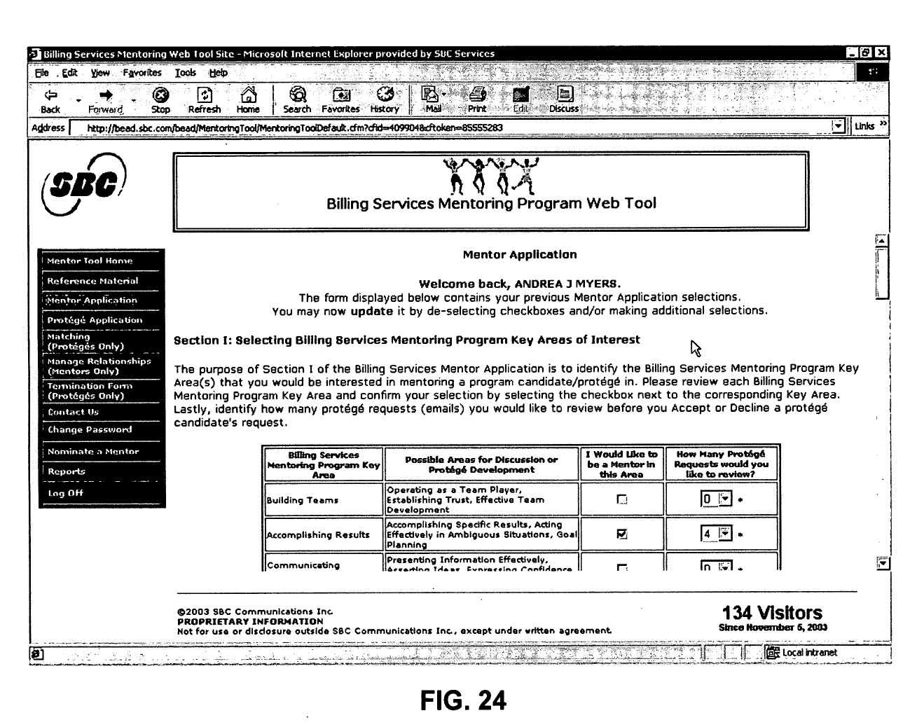

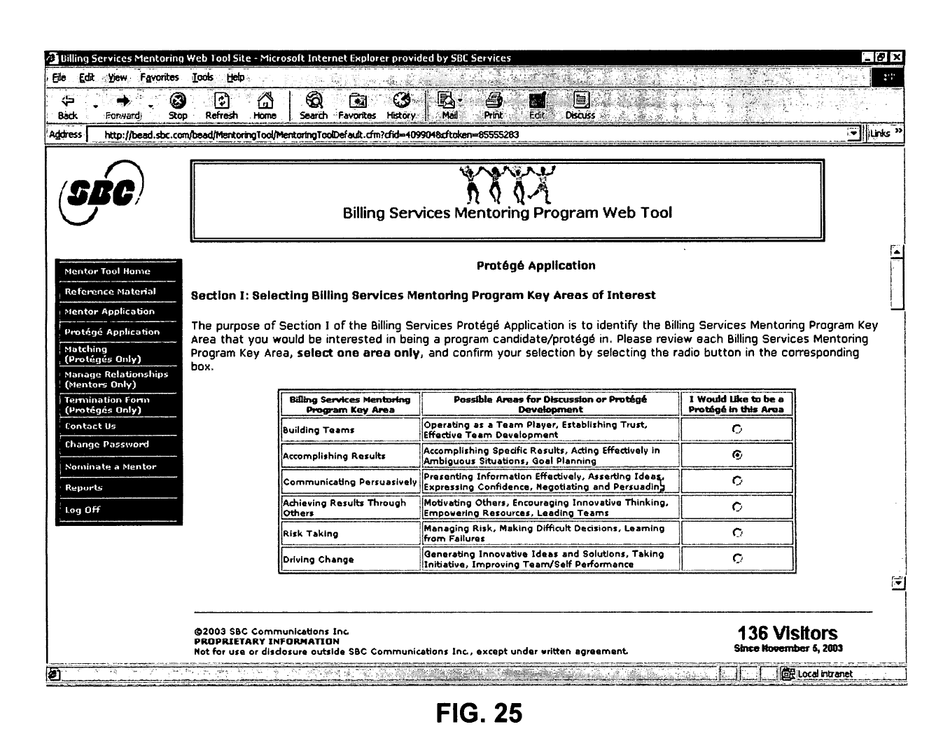

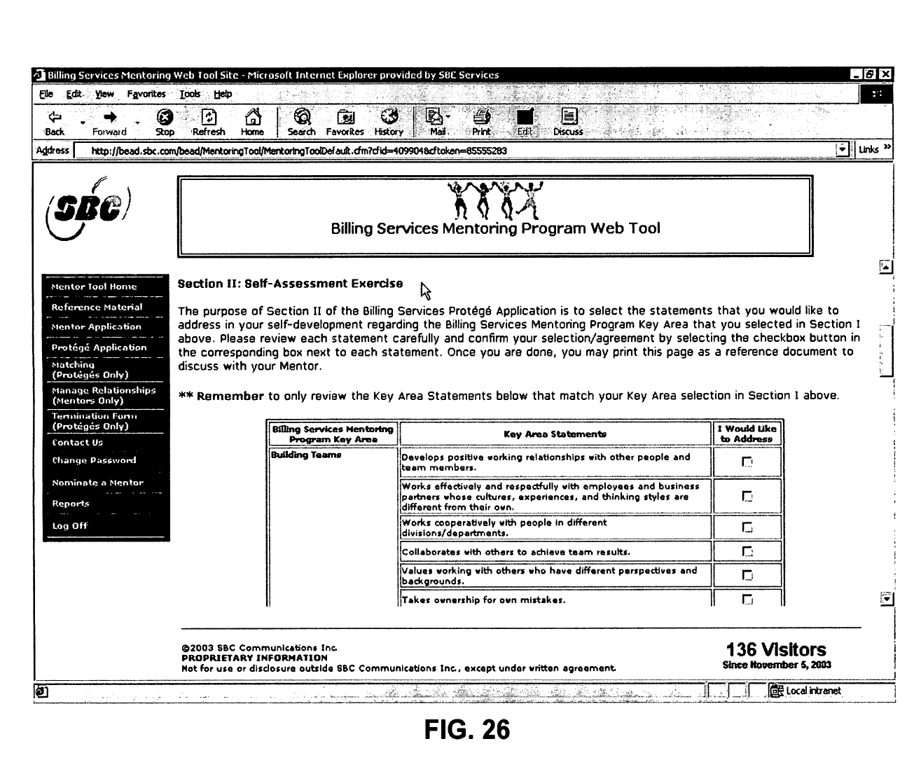

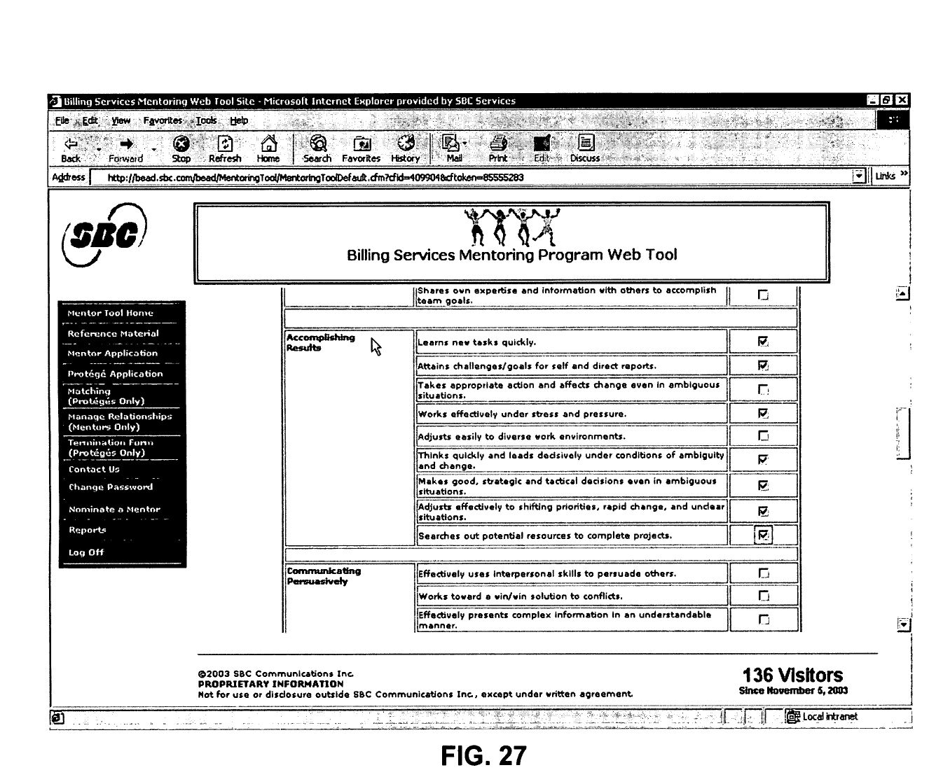

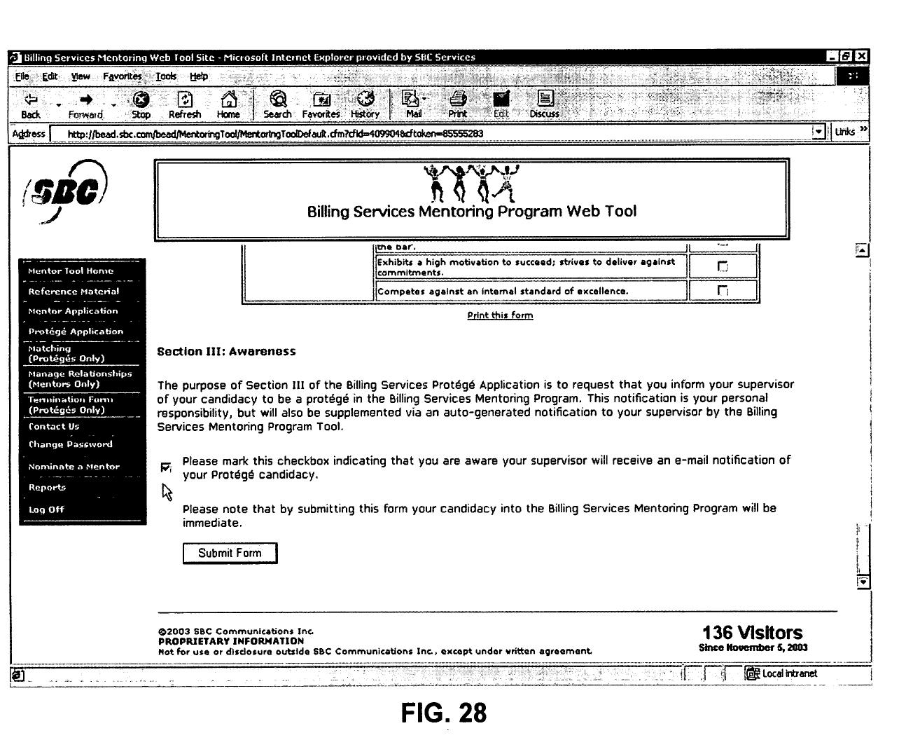

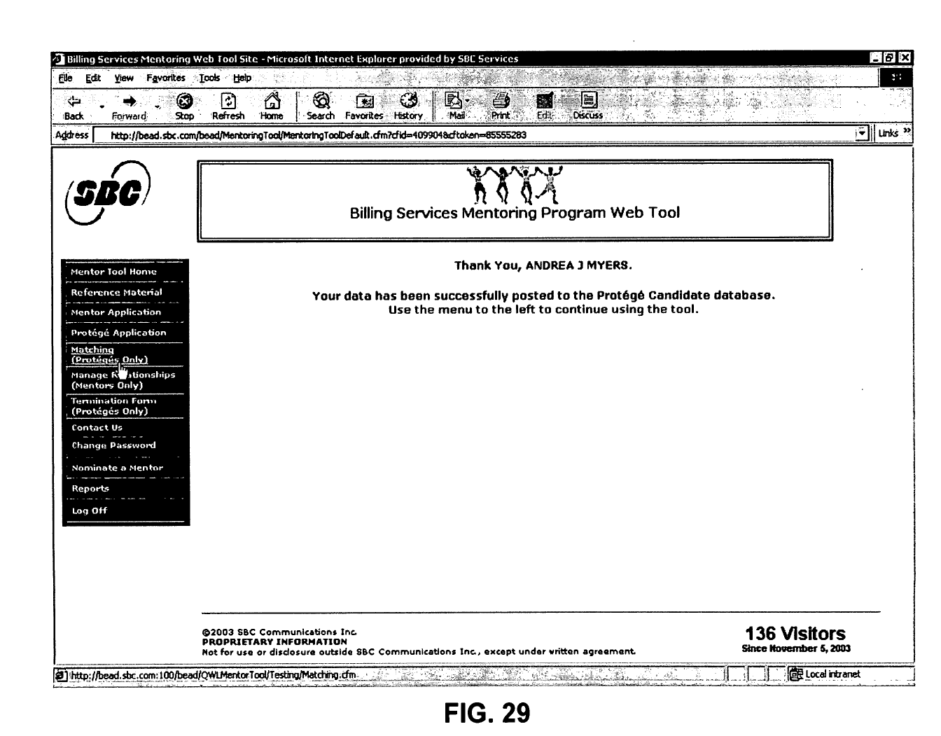

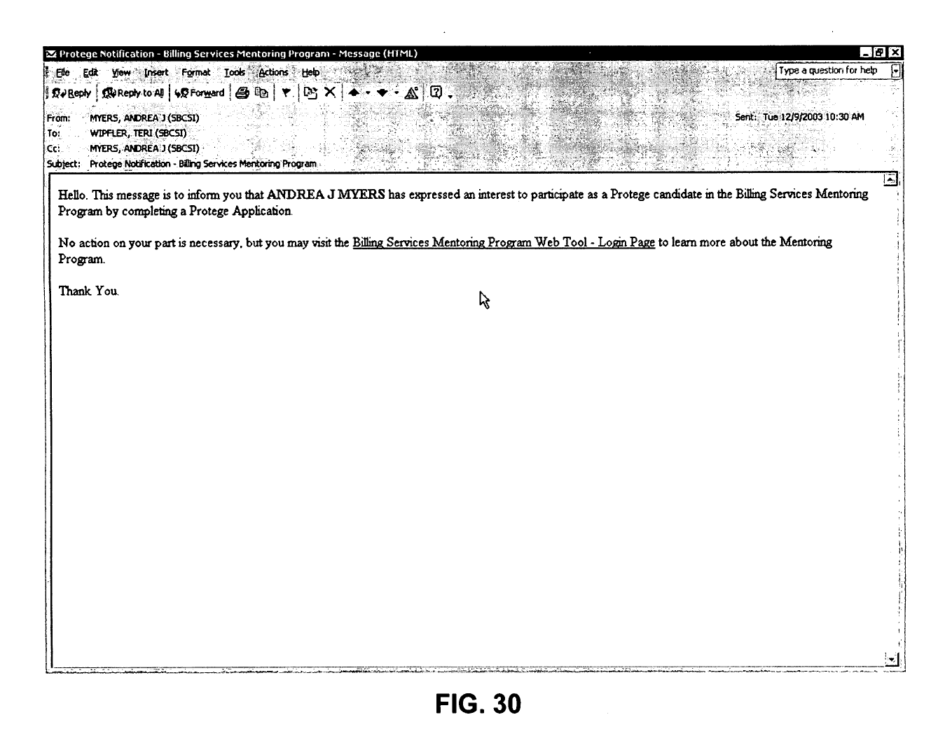

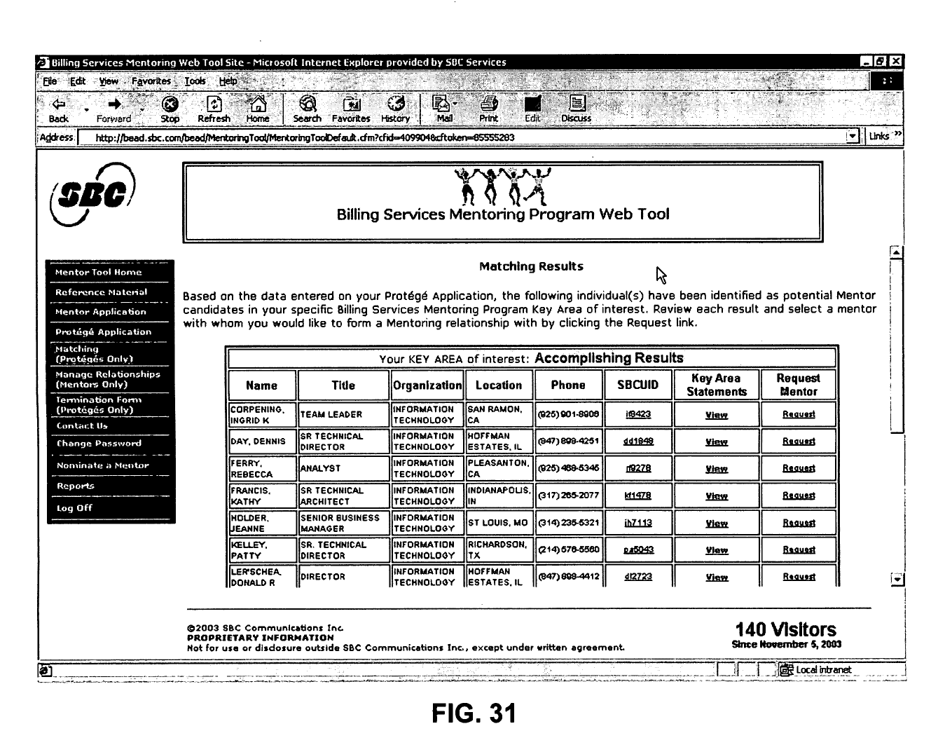

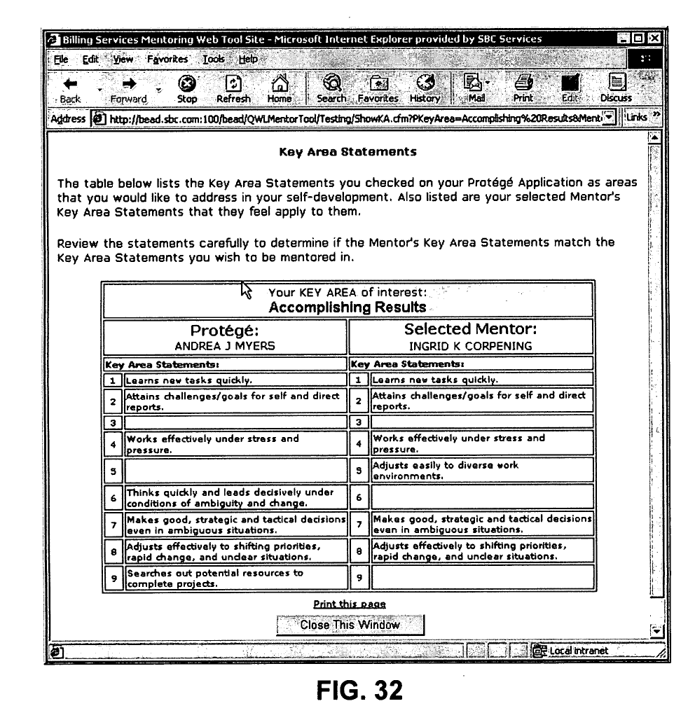

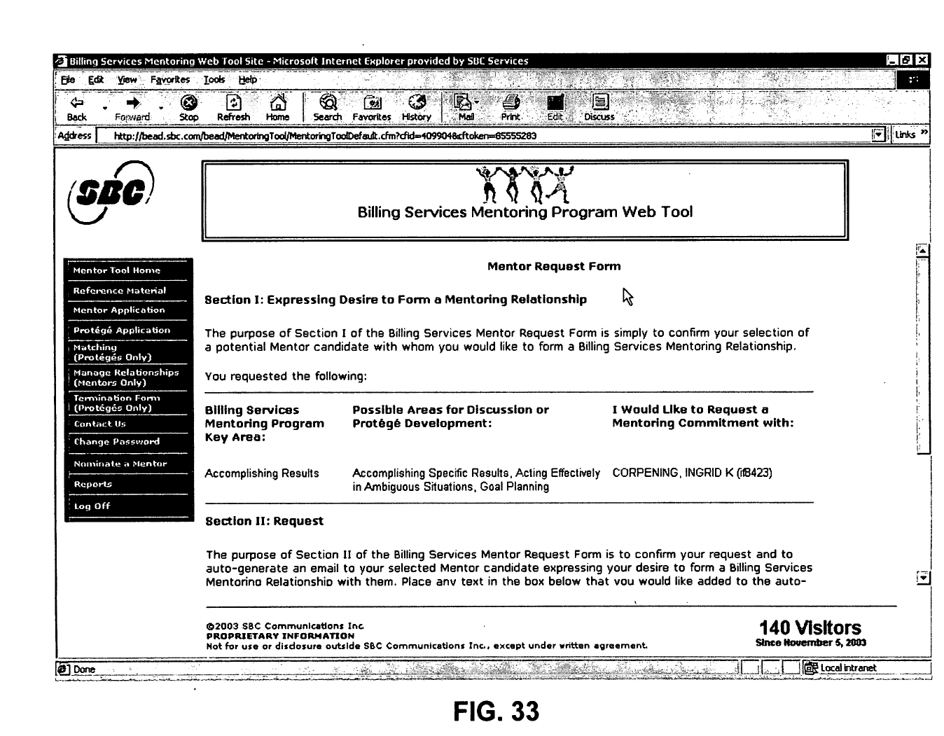

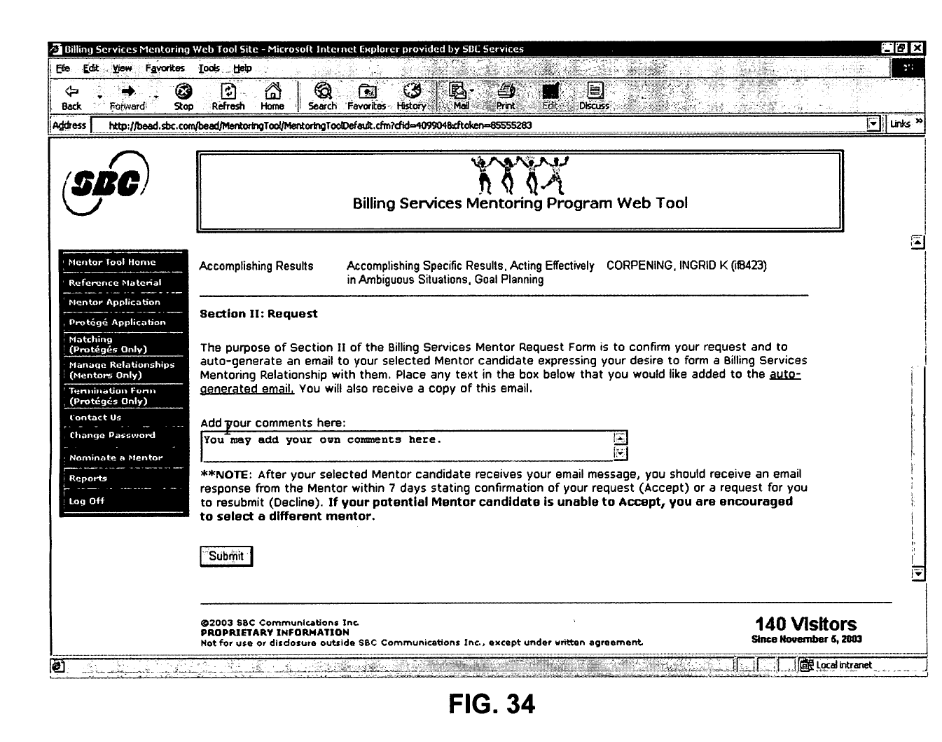

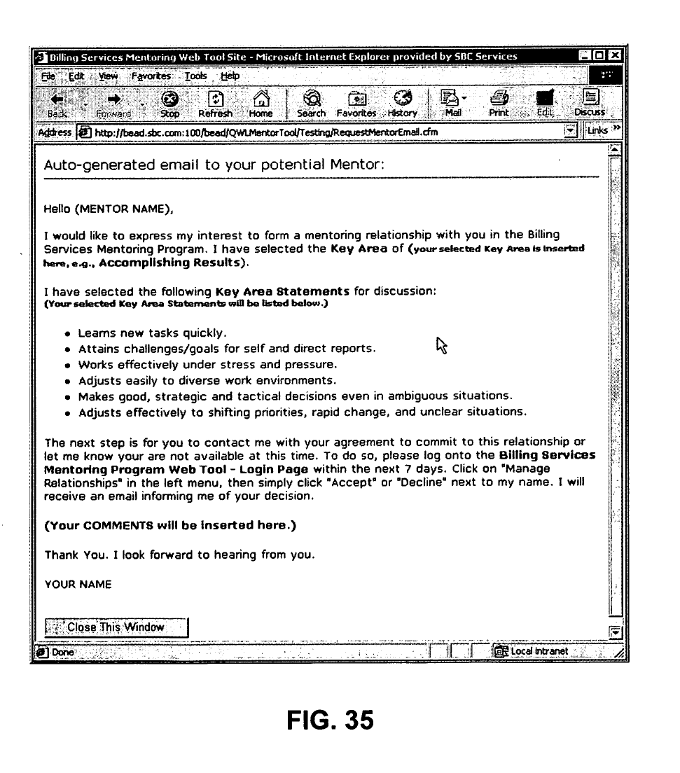

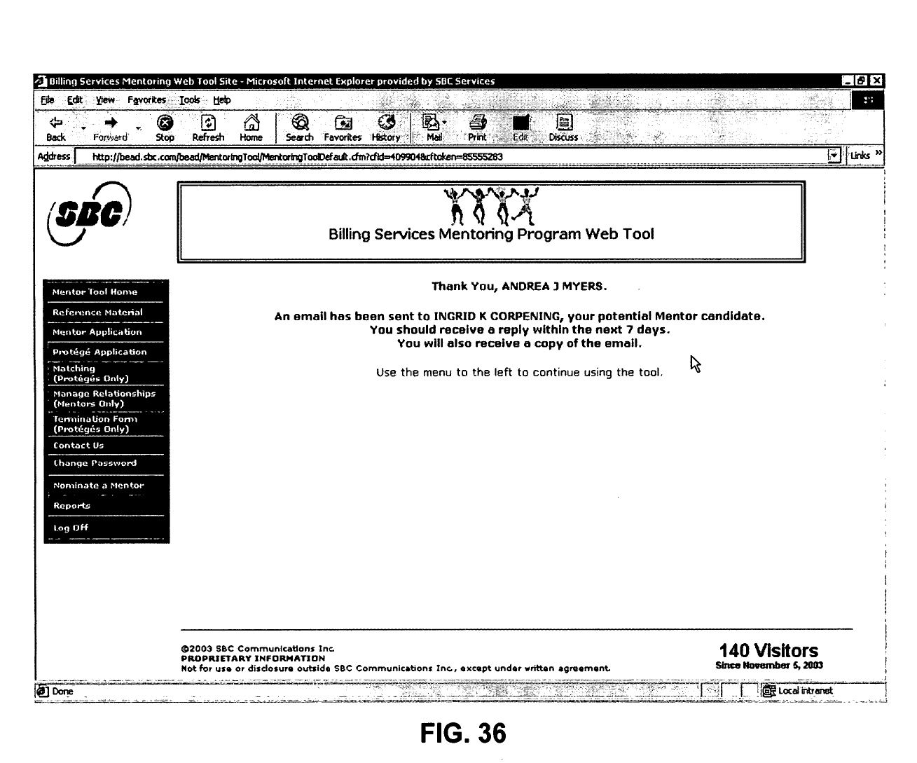

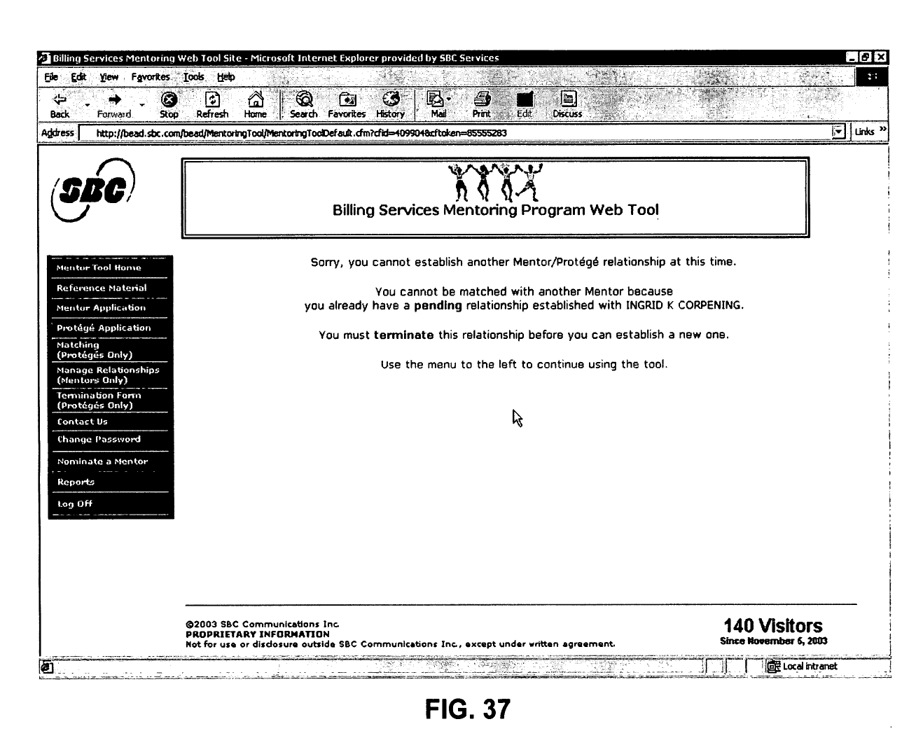

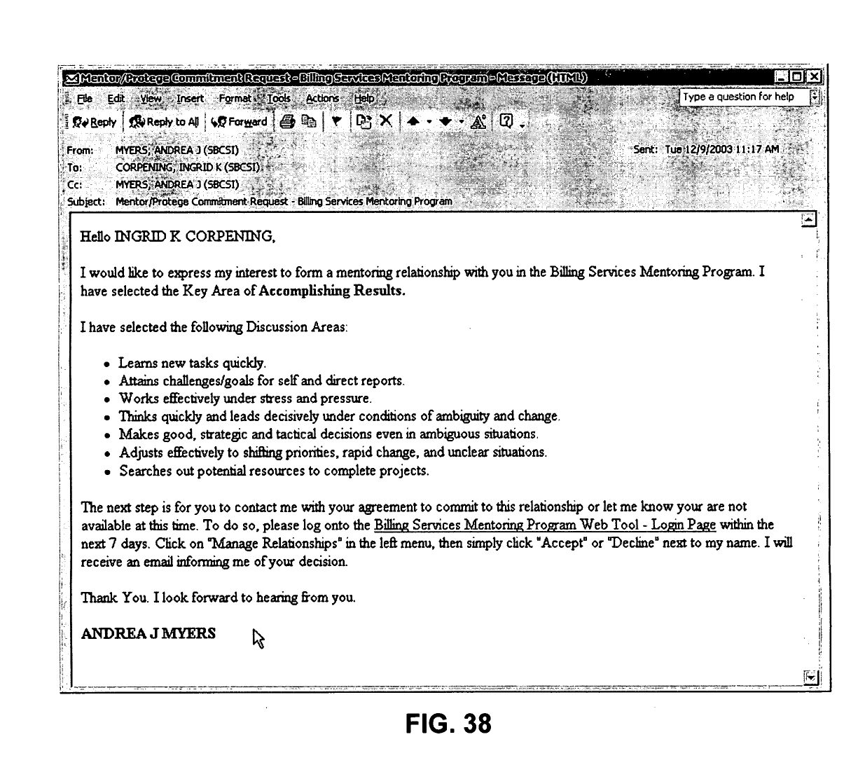

FIG. 15 depicts an exemplary embodiment of a GUI that can be used to access various reference materials associated with the mentoring relationship management tool. FIG. 16 through FIG. 24 show exemplary embodiments of a GUI that can be used to complete a mentor application. Further, FIG. 25 through FIG. 30 illustrate exemplary embodiments of a GUI that can be used to complete a protégé application. FIG. 31 through FIG. 32 depict exemplary embodiments of a GUI that can be used to indicate matches between mentors and protégés. FIG. 33 through FIG. 38 indicate exemplary embodiments of a GUI that can be used to accept a match with a mentor.

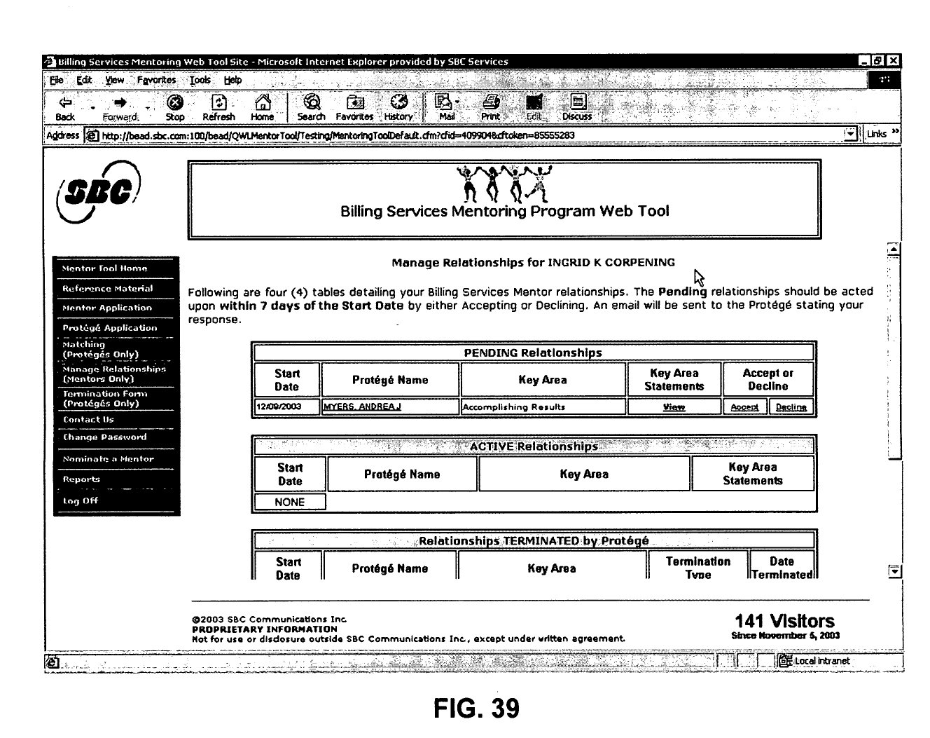

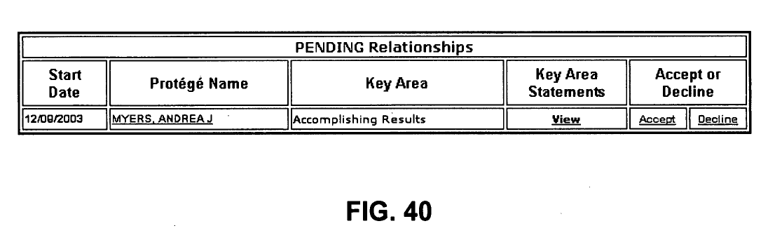

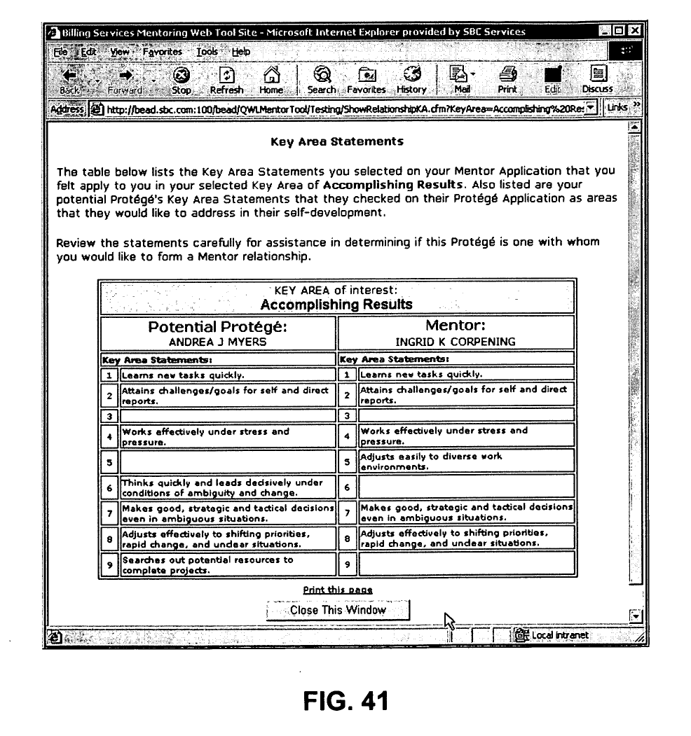

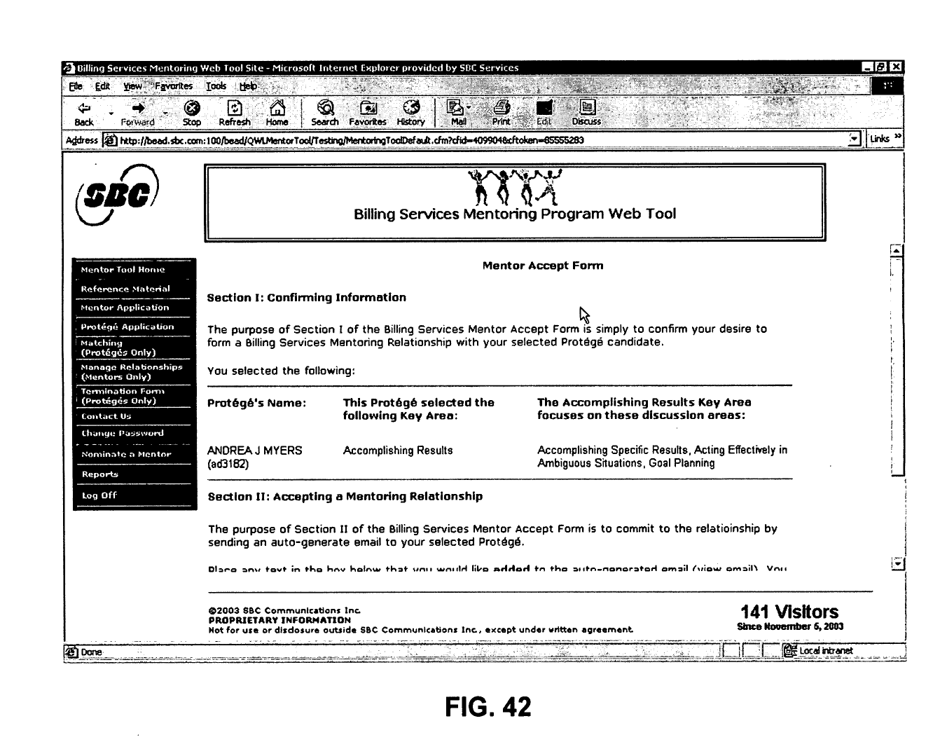

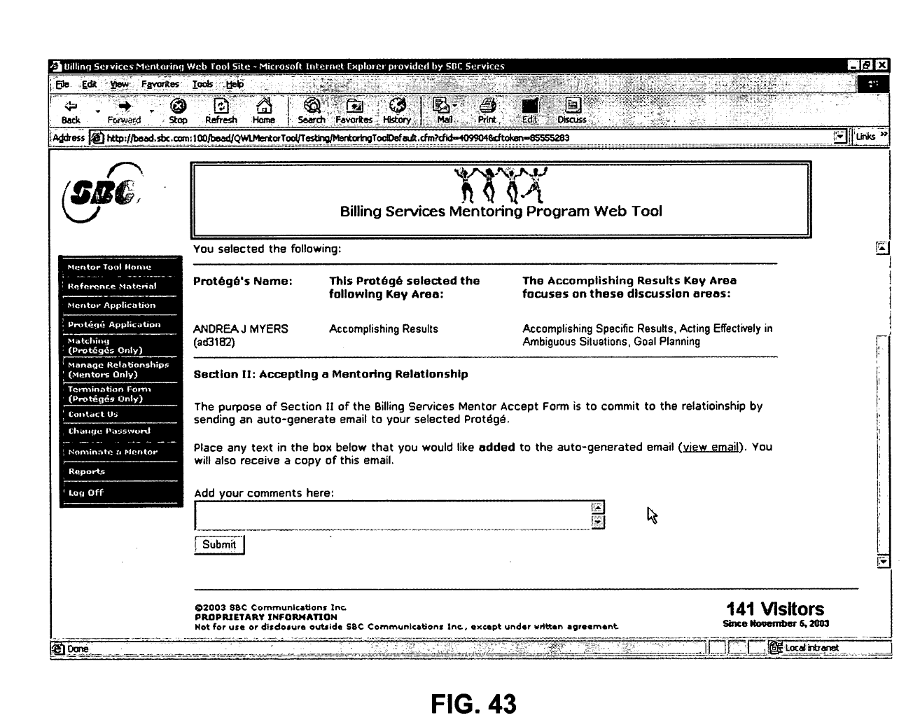

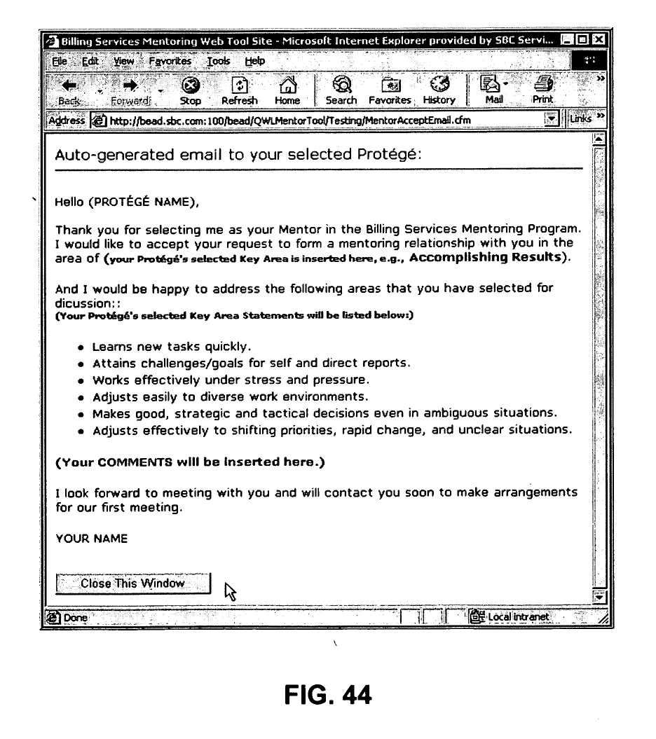

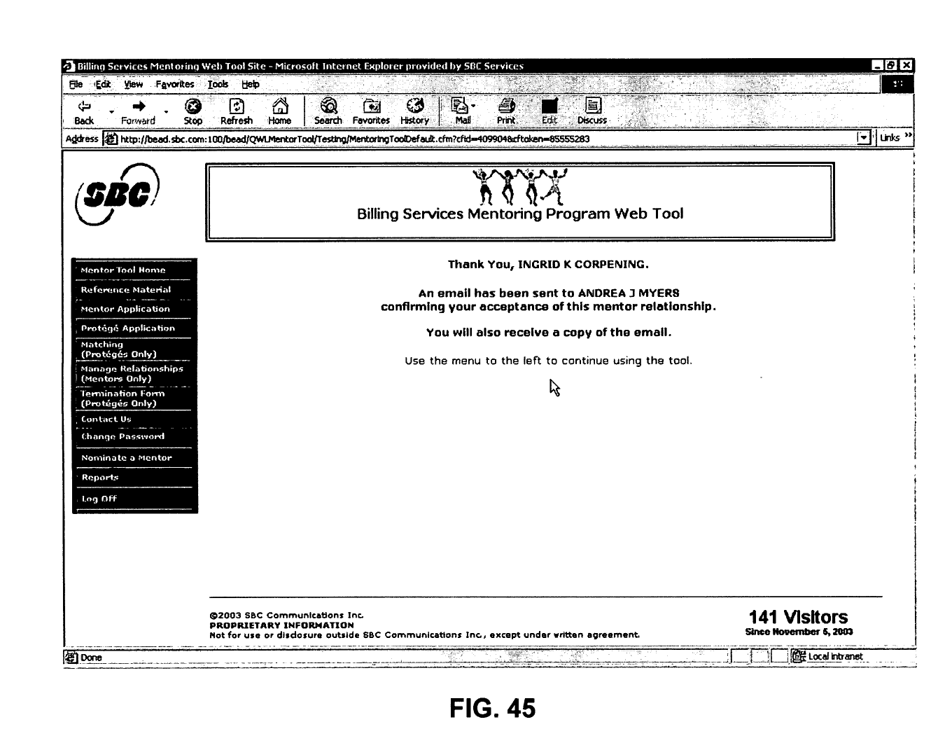

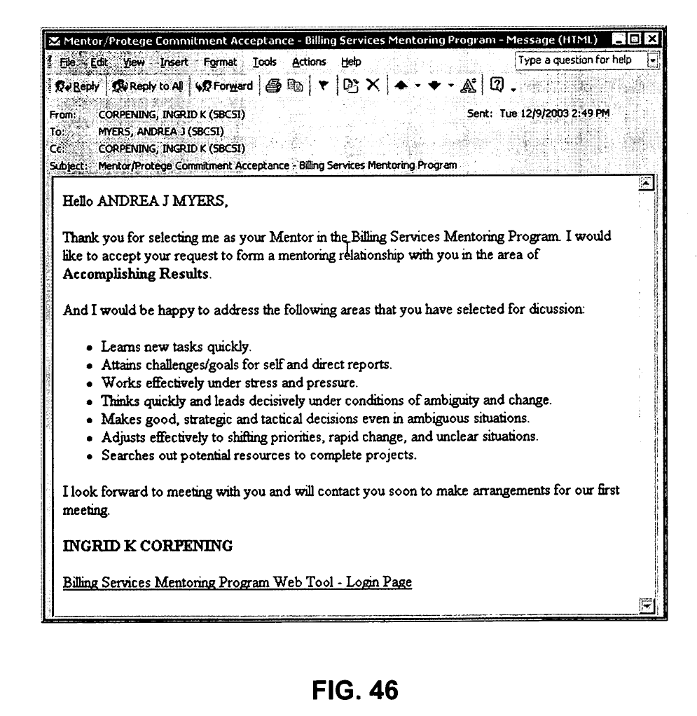

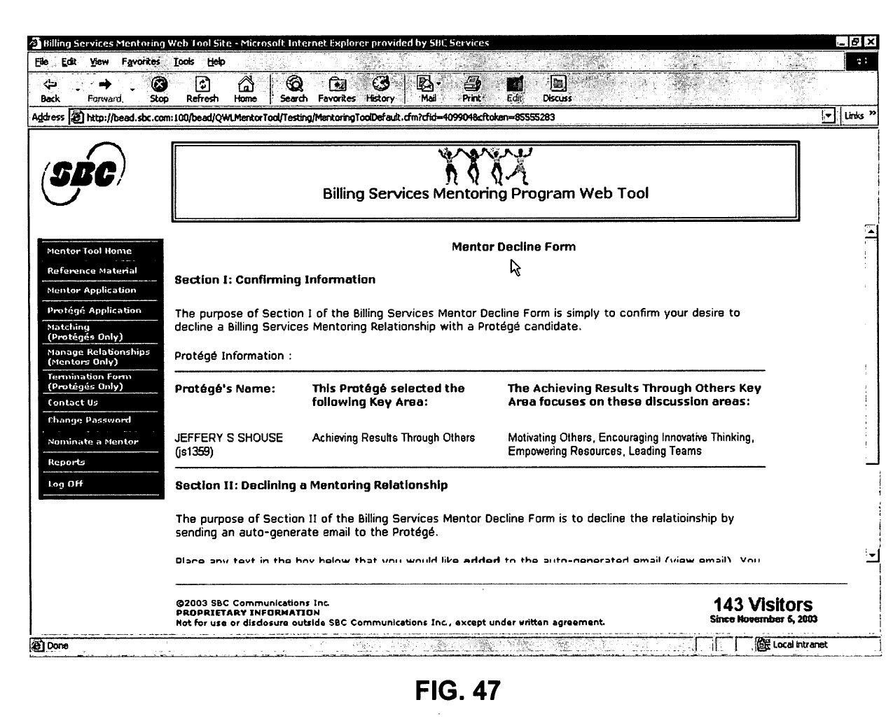

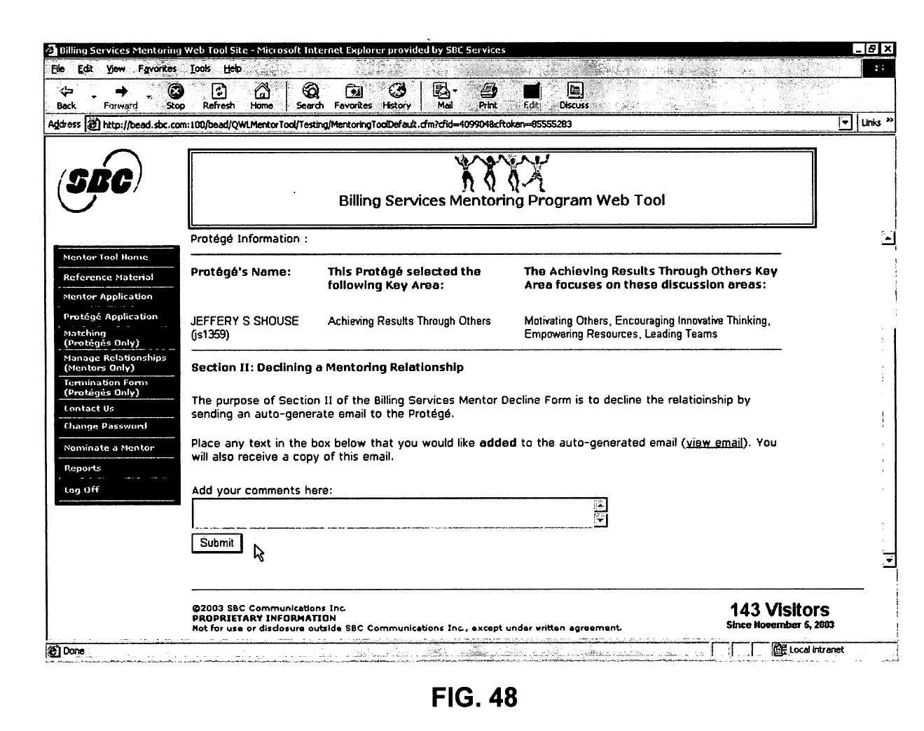

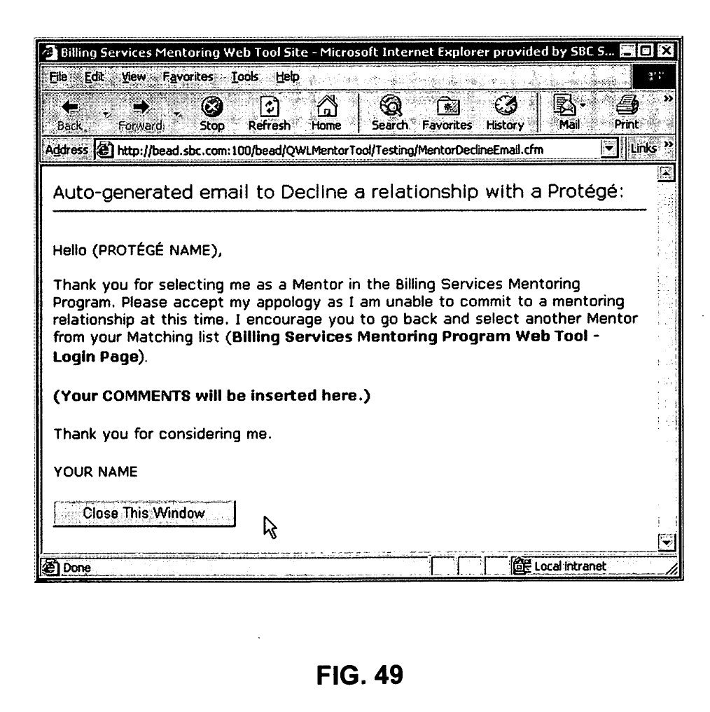

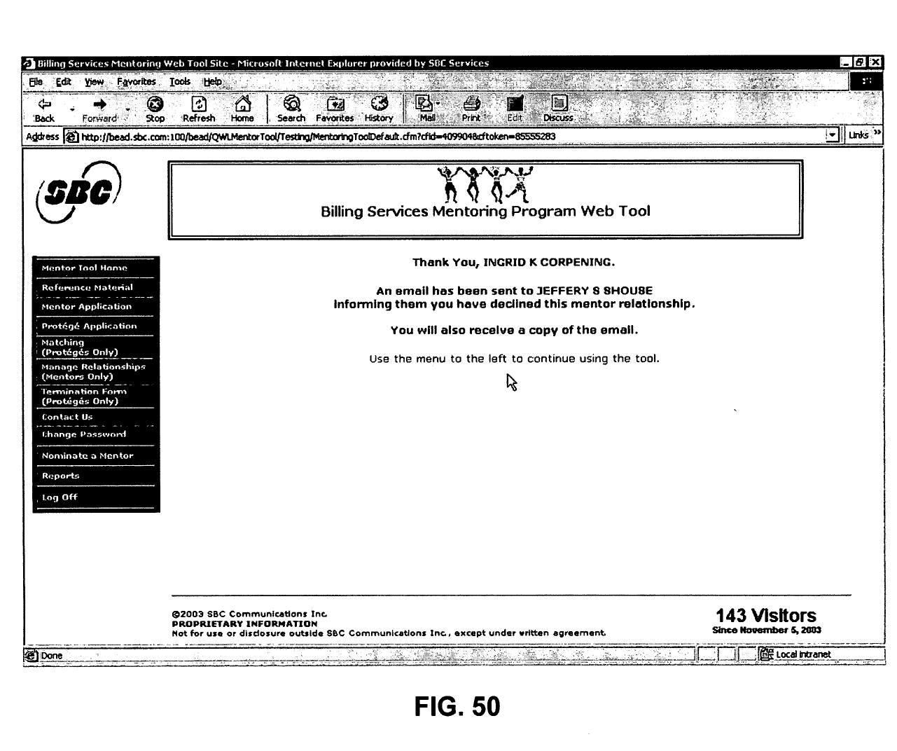

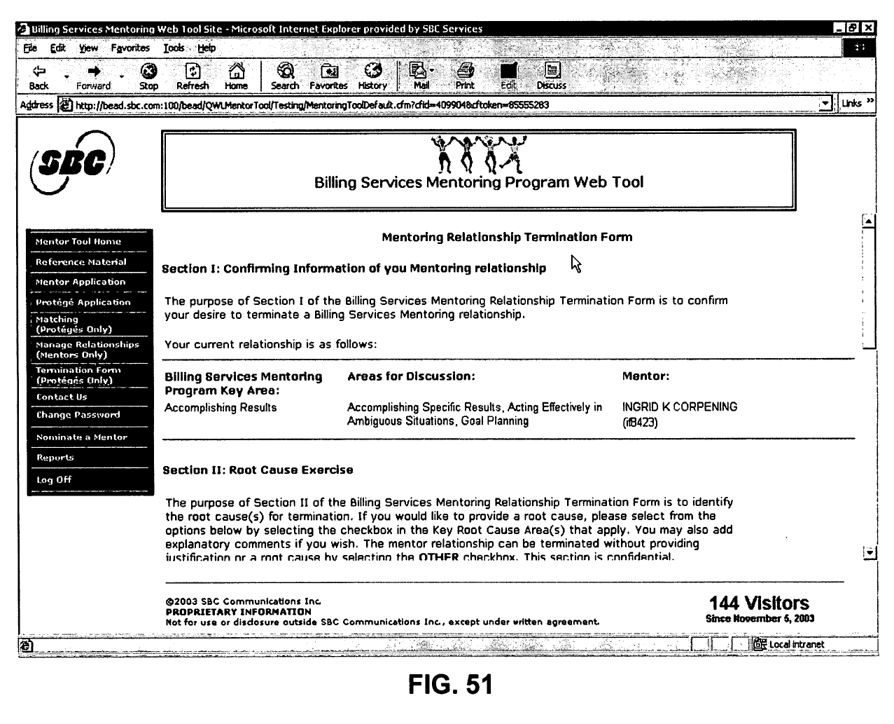

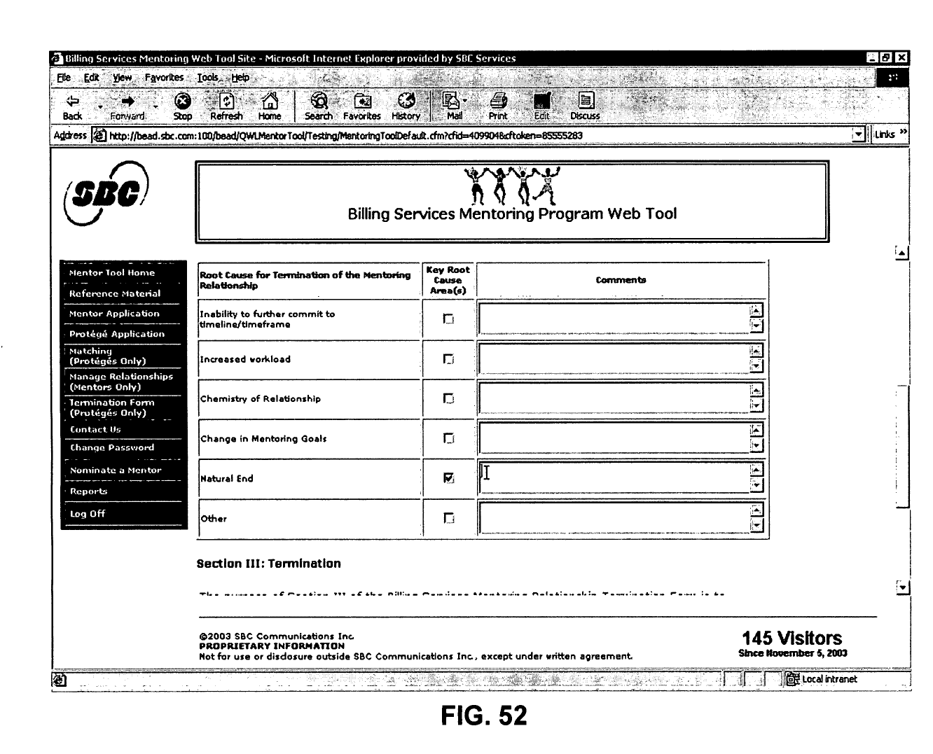

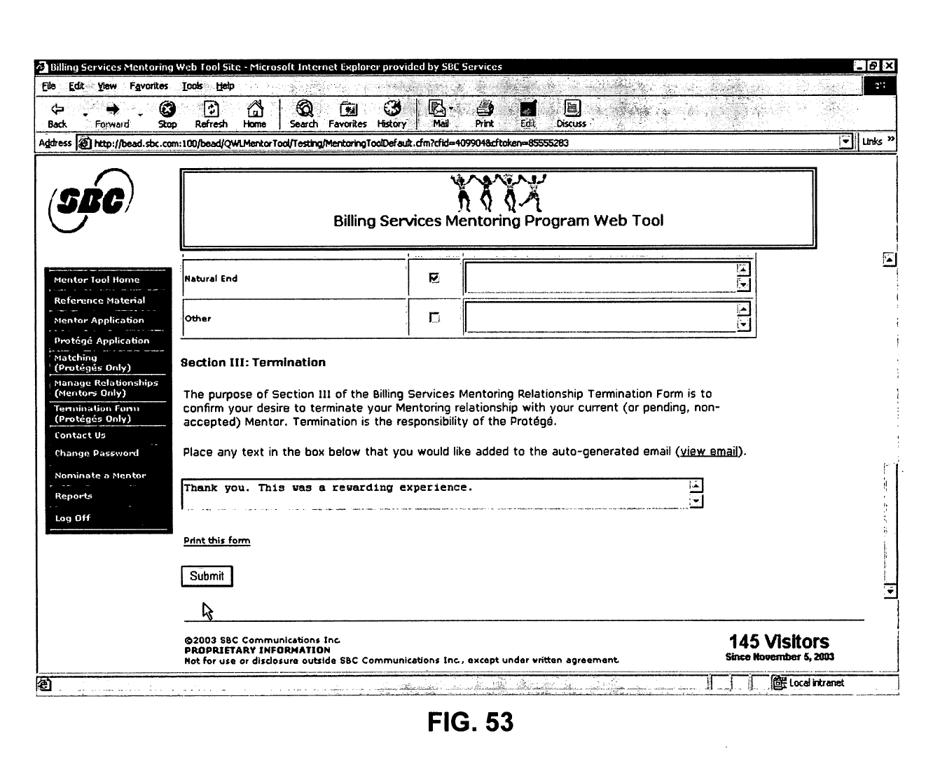

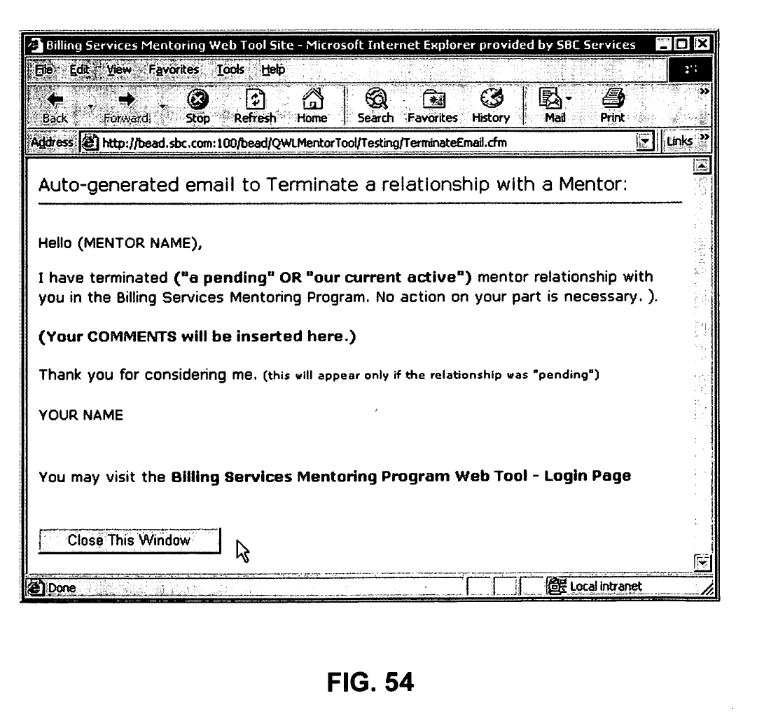

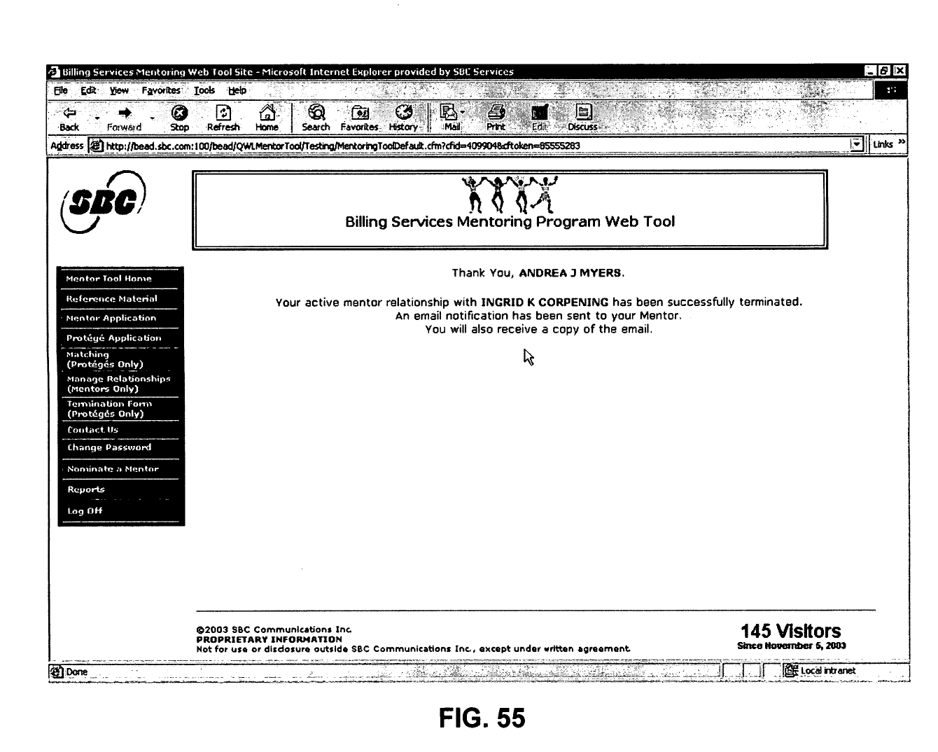

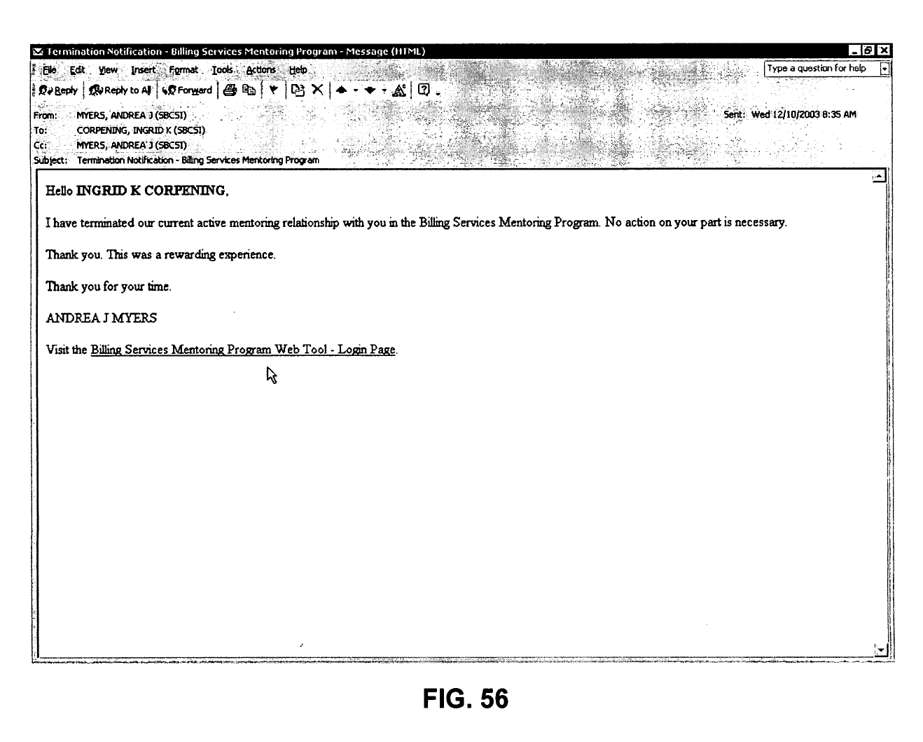

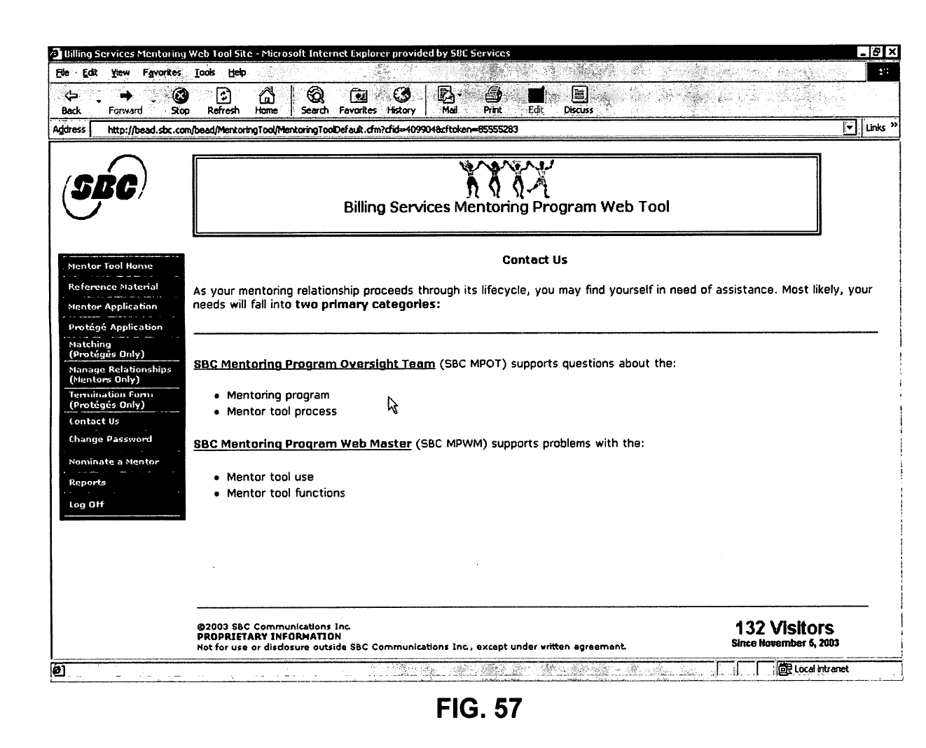

FIG. 39 through FIG. 50 illustrate exemplary embodiments of a GUI that can be used to manage mentoring relationships. In a particular embodiment, only a mentor can manage his or her mentoring relationships. FIG. 51 through FIG. 56 show exemplary embodiments of a GUI that can be used to terminate a mentoring relationship between a mentor and a protégé. In a particular embodiment, the GUI shown in FIG. 51 through FIG. 56 provides one or more termination survey forms that can be completed by a protégé or a mentor after a mentoring relationship has been terminated. Additionally, FIG. 57 shows an exemplary embodiment of a GUI that can be used to contact a mentoring relationship management server.

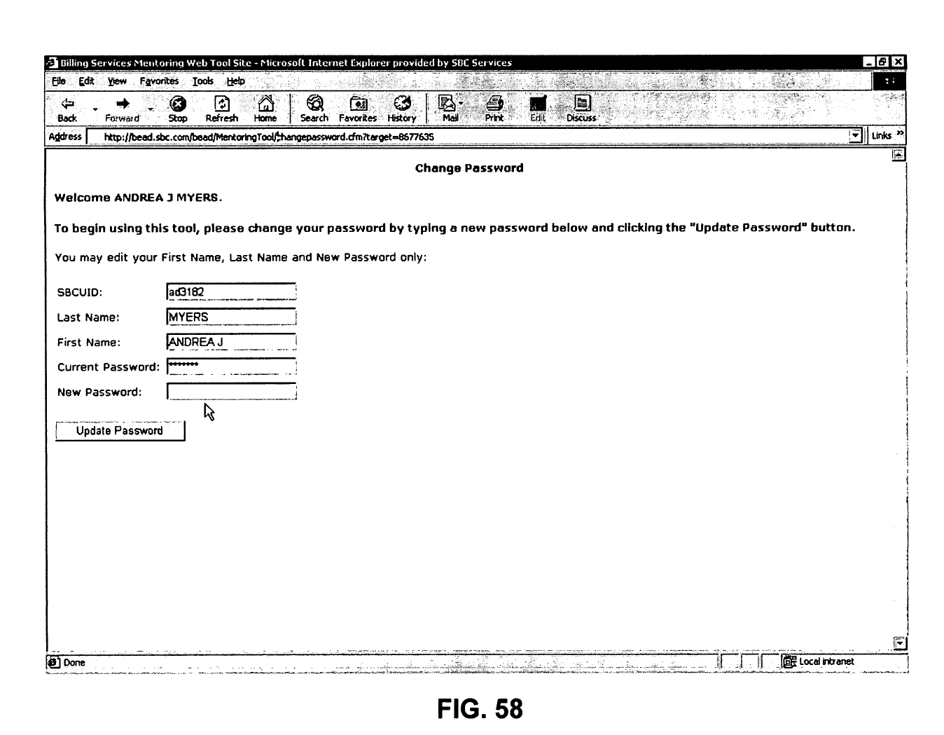

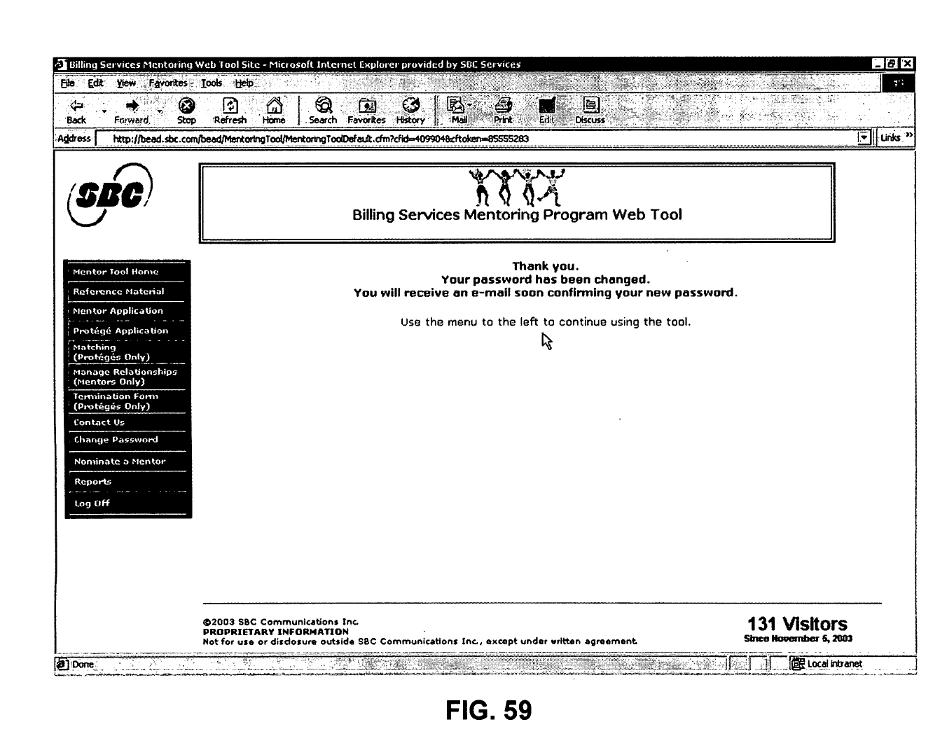

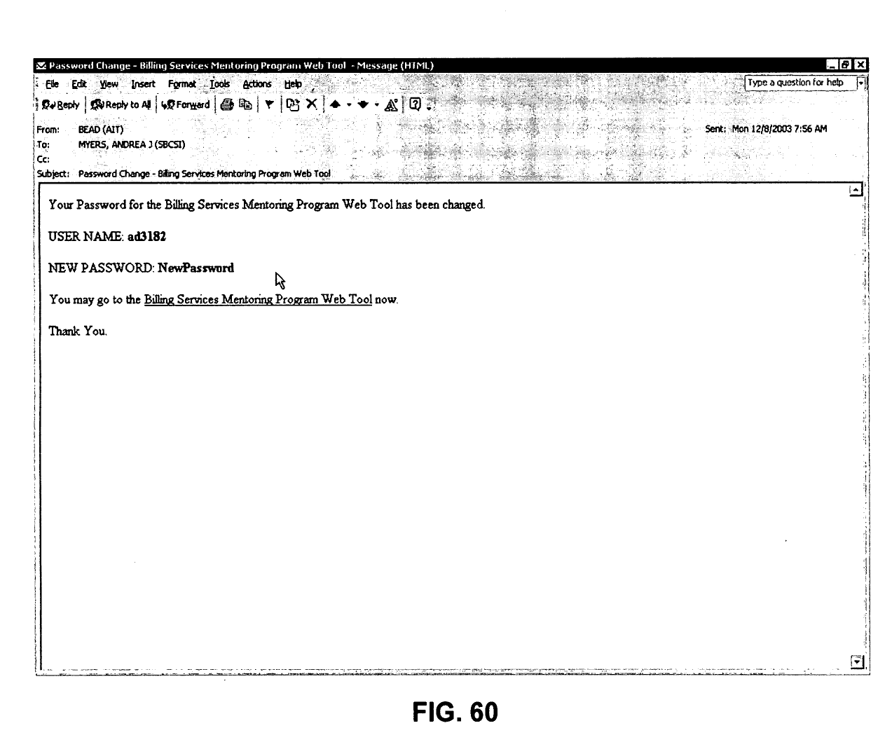

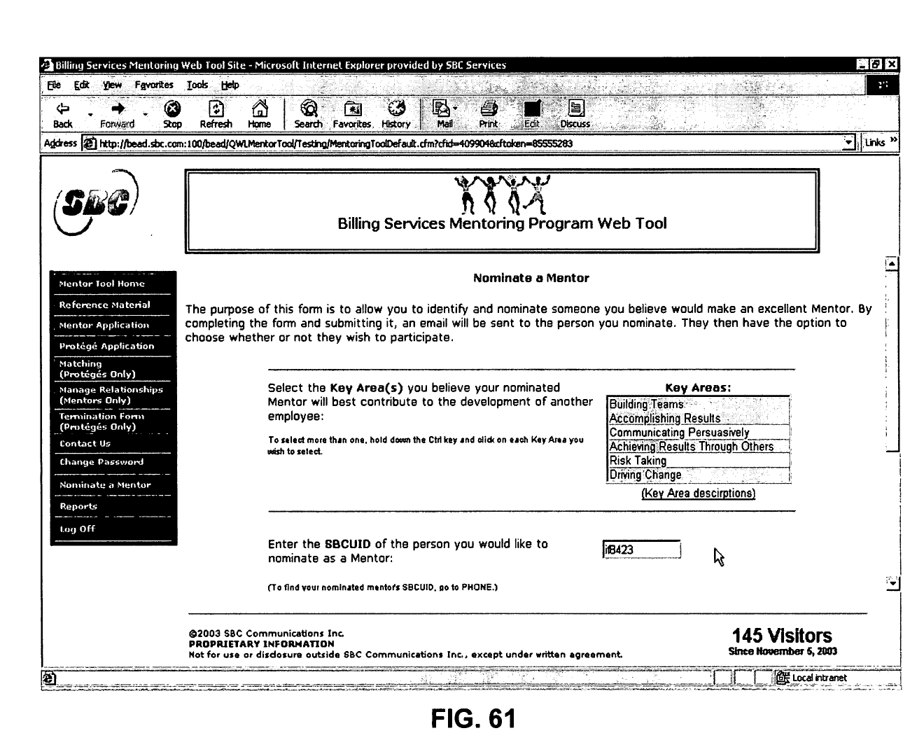

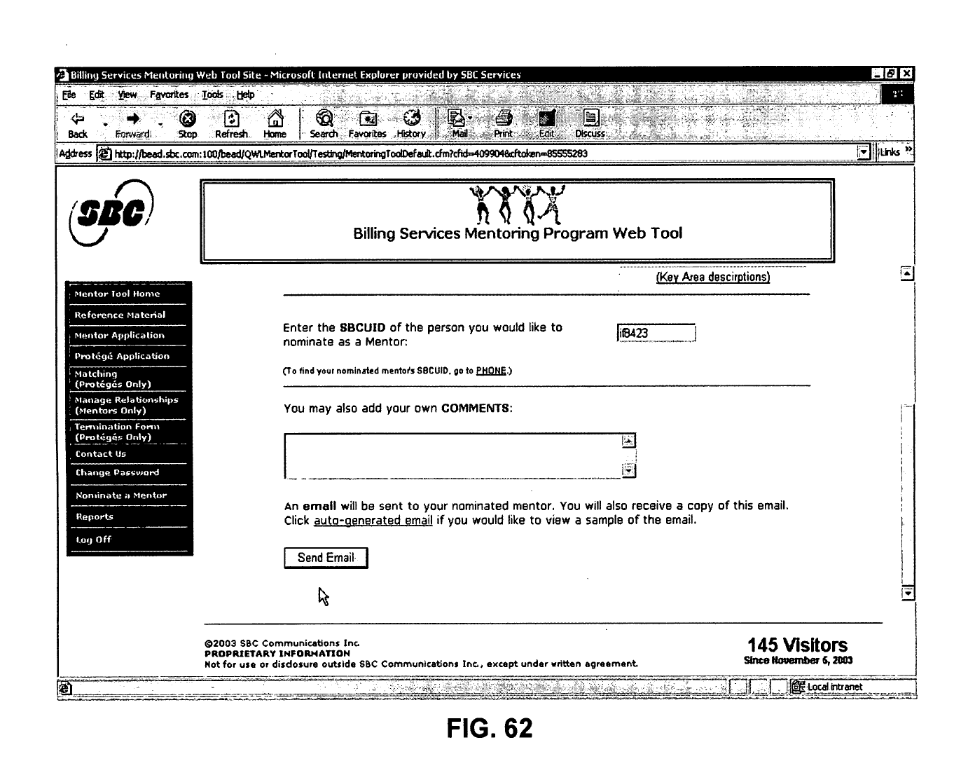

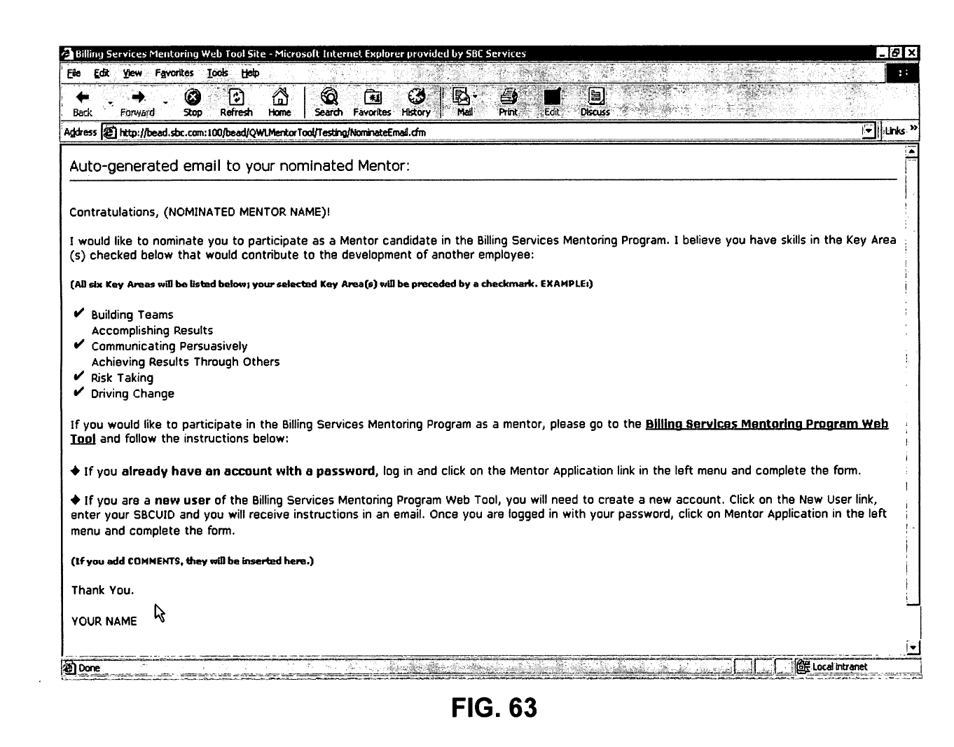

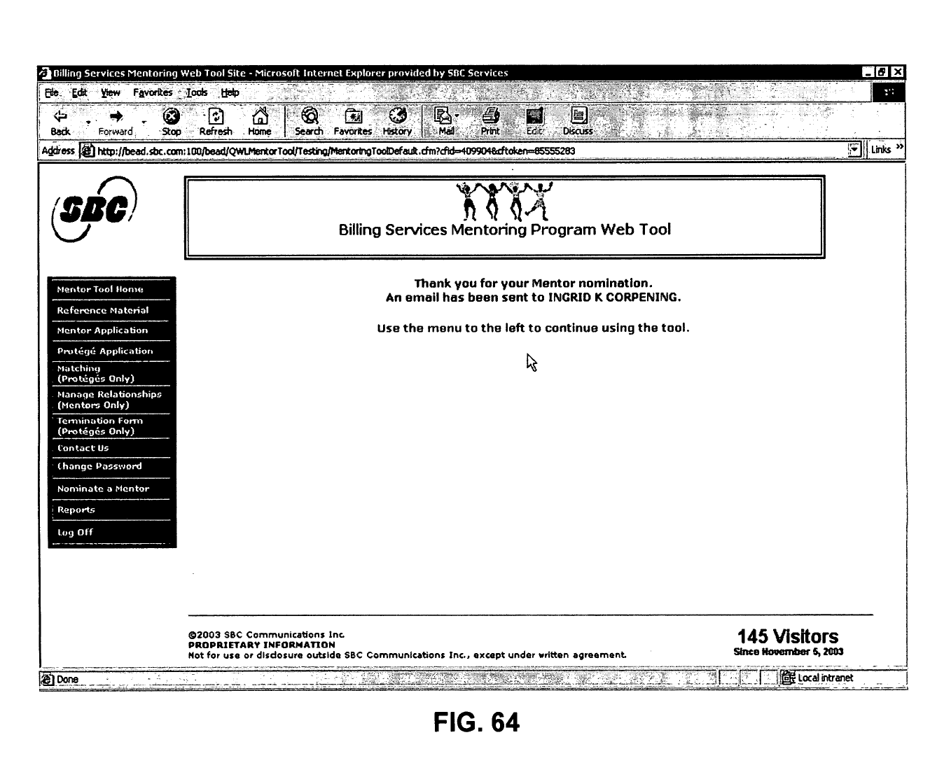

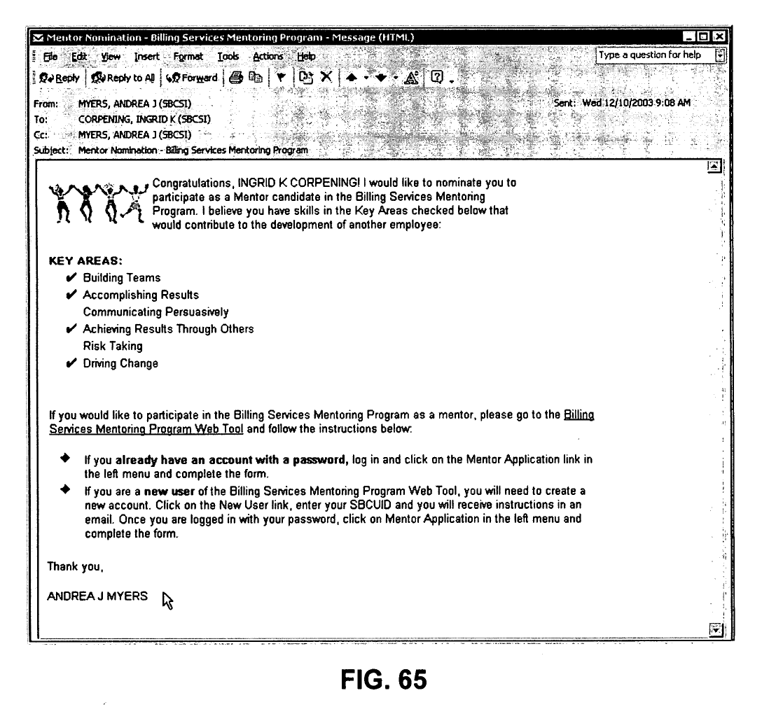

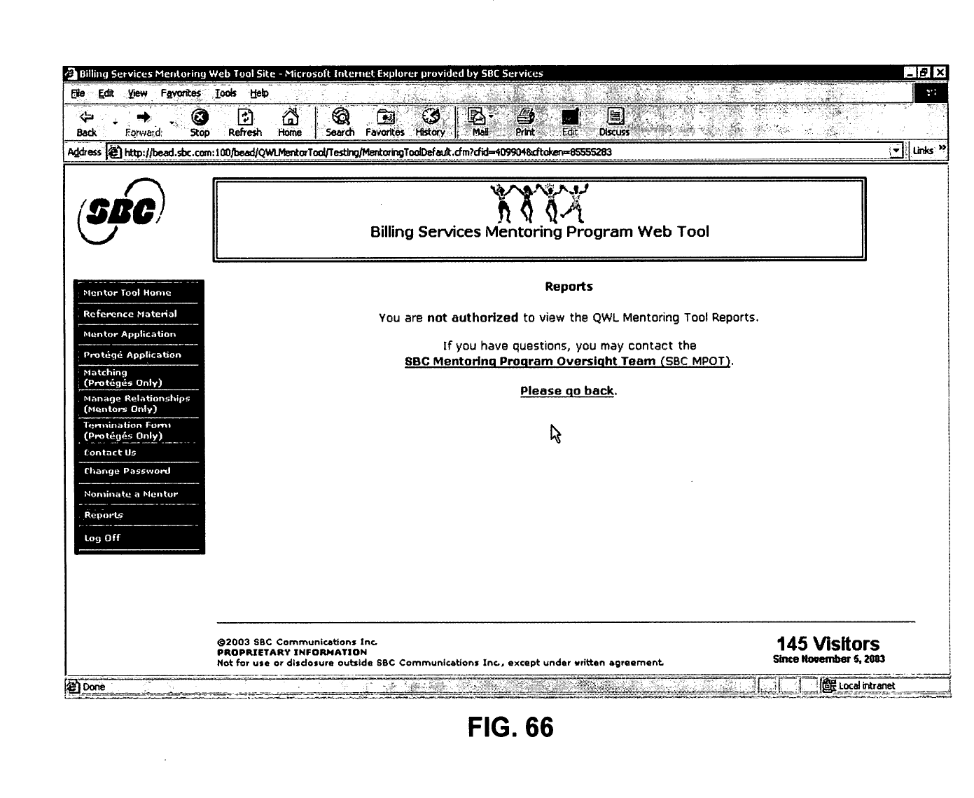

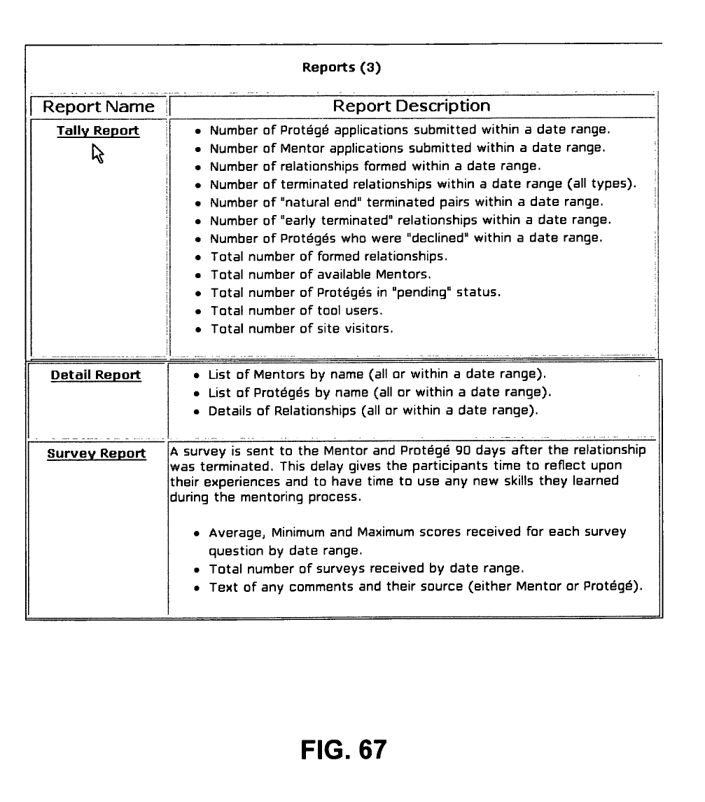

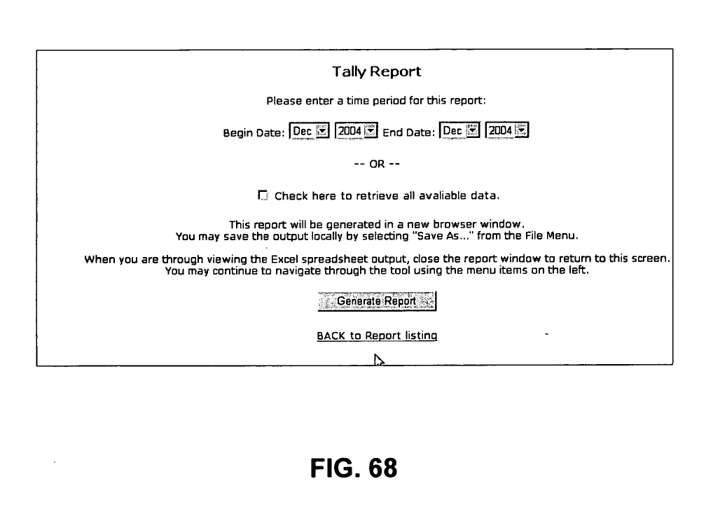

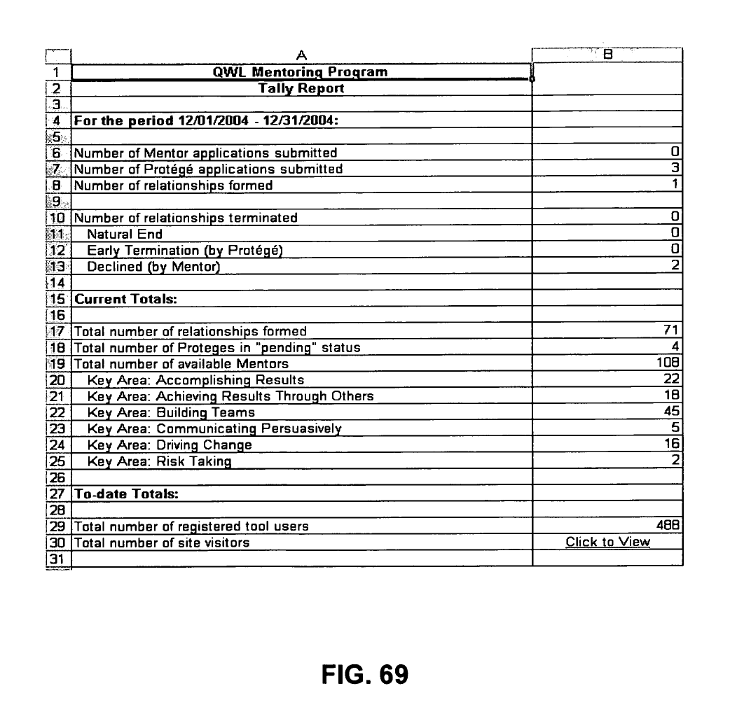

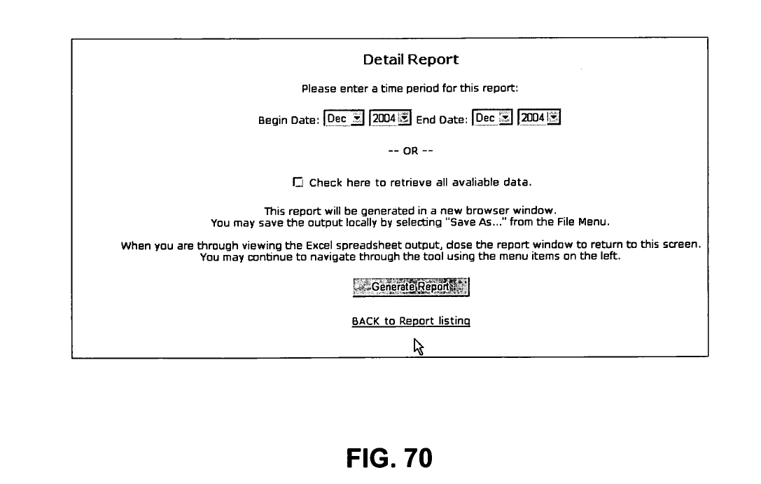

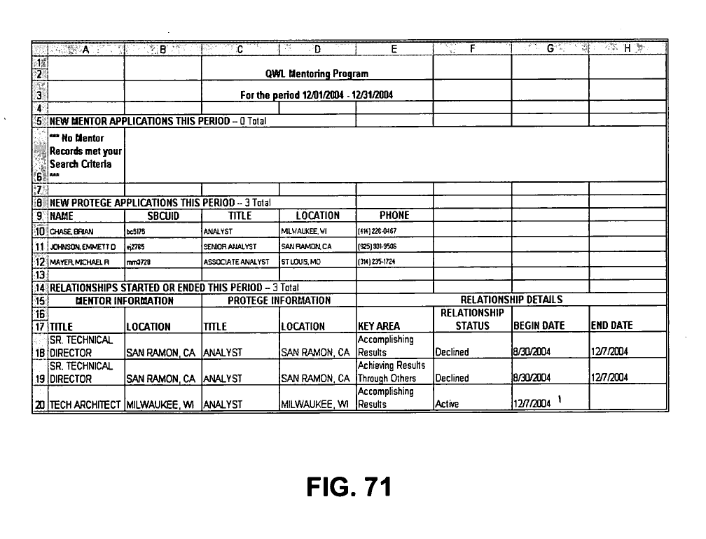

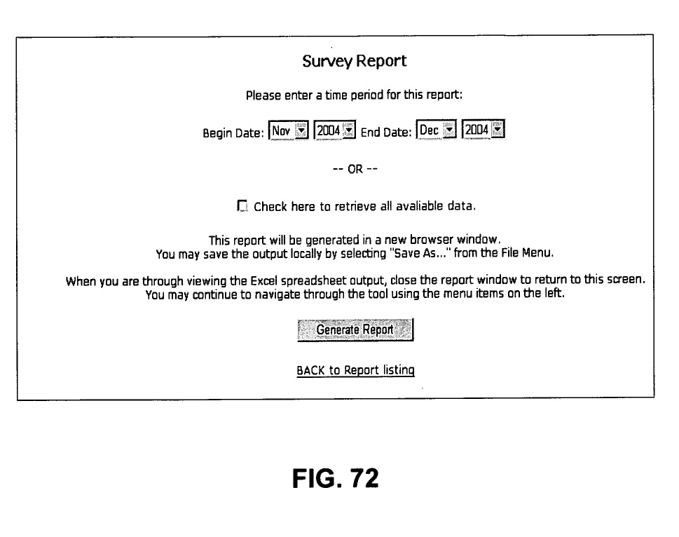

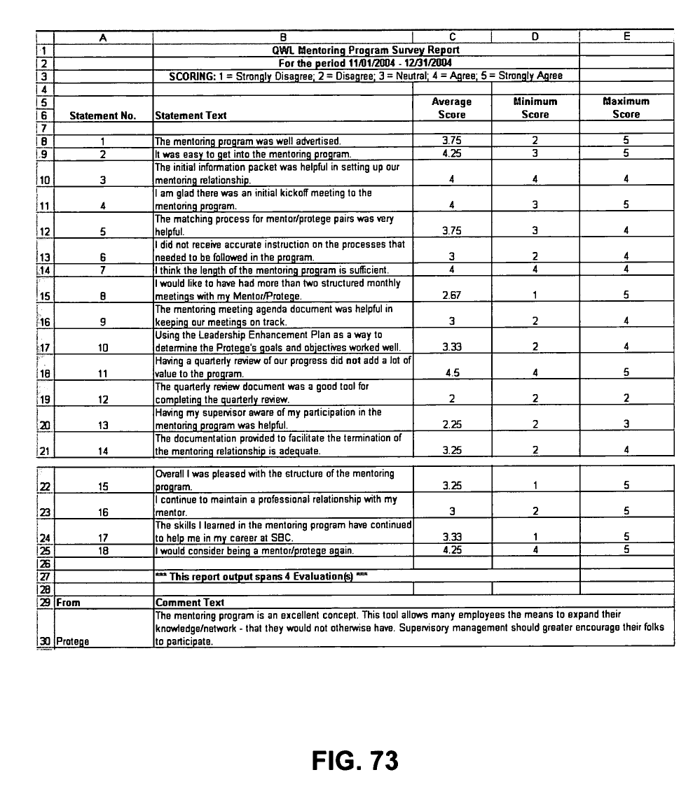

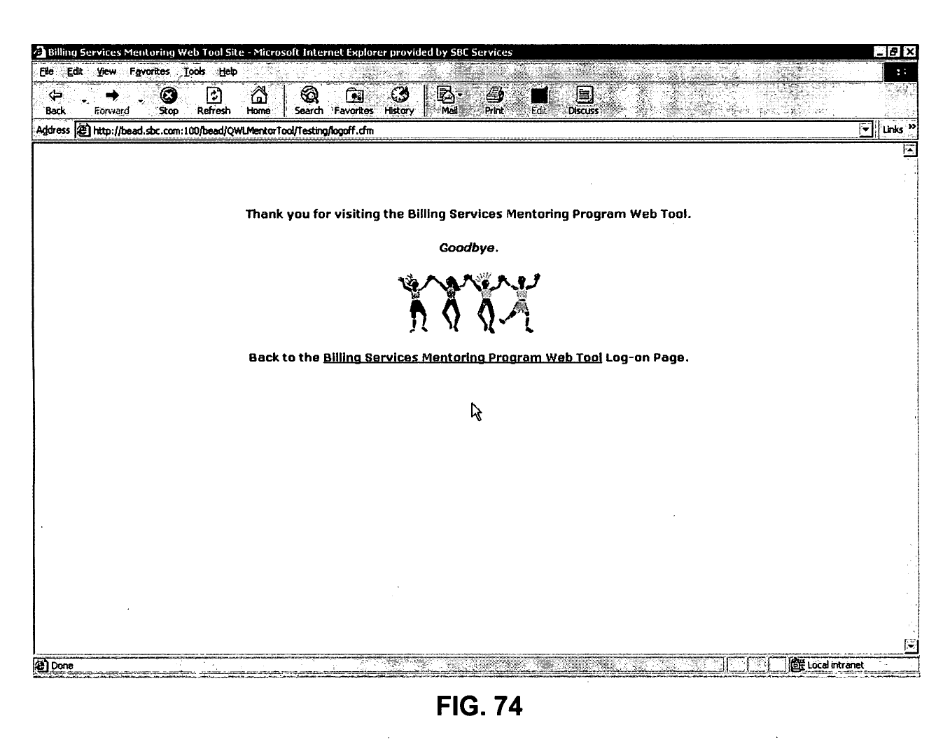

FIG. 58 through FIG. 60 illustrate exemplary embodiments of a GUI that can be used to change a password for the mentoring relationship management server. FIG. 61 through FIG. 65 depict exemplary embodiments of a GUI that can be used to nominate a mentor. In a particular embodiment, any third party can nominate someone to become a mentor. FIG. 66 through FIG. 73 show exemplary embodiments of a GUI that can be used to report information related to one or more mentoring relationships based on one or more termination surveys completed by a mentor or protégé. FIG. 74 depicts an exemplary embodiment of a GUI that can be used to indicate that a user has logged off of the mentoring relationship management tool.

With the configuration of structure described above, the system and method of managing mentoring relationships provides a way to initiate the mentor and protégé candidacy process. Further, the developmental needs of particular protégés can be determined and matched with mentors who indicate particular qualities matching those developmental needs. Also, the system and method of managing mentoring relationships can determine available mentors, establish mentoring relationships between mentors and protégés, and terminate the mentoring relationships when requested by either party.

The system and method described above can provide increased productivity at both the organization level and individual level. Further, increased organizational communication and understanding can be provided. Also, the system and method can provide improved strategic planning and succession planning at the organization level and the individual level. The system and method can also provide increased leadership effectiveness.

In a particular embodiment, the system and method disclosed herein also provides a built in feedback loop for continual program and process improvement. Particularly, at the end of a mentoring relationship one or more surveys are generated and communicated to each mentor and protégé. These surveys can be used to measure and evaluate the program and also to evaluate each user's total experience in the program. The feedback provided by the surveys can then be used to make updates to the process and any program documentation on a continual basis.

Additionally, the system and method provides a function wherein mentors can be nominated by third parties. Thus, mentors who may not think they should be mentors can be nominated by others who think differently. Further, the system and method allows a user to select a profile, e.g., mentor or protégé, and the profile can limit the user's access to the mentoring relationship server. During the relationship, each user can not change his or her profile and must adhere to the program guidelines for the chosen profile. Also, a mentor can pre-select how many protégés that he or she can support at one time. Once that threshold is reached, the mentor's name will no longer be listed as an available mentor for potential protégés.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
receiving a plurality of completed mentor applications;
receiving a plurality of completed protégé applications;
matching one of the plurality of completed mentor applications with one of the plurality of completed protégé applications to create a mentoring relationship;
receiving an indication to terminate the mentoring relationship; and
generating a first termination survey for a mentor associated with the mentoring relationship.

2. The method of claim 1, further comprising generating a second termination survey for a protégé associated with the mentoring relationship.

3. The method of claim 2, further comprising communicating the first termination survey to the mentor associated with the mentoring relationship.

4. The method of claim 3, further comprising communicating the second termination survey to the protégé associated with the mentoring relationship.

5. The method of claim 4, wherein the first termination survey and the second termination survey comprise one or more user selectable root cause statements.

6. The method of claim 5, wherein the one or more root cause statements is selected from the group consisting of: “Inability to further commit to timeline/timeframe,” “Increased workload,” “Chemistry of Relationship,” “Change in Mentoring Goals,” “Natural End,” and “Other.”

7. The method of claim 5, further comprising transmitting a follow-up survey to the mentor and to the protégé.

8. The method of claim 7, wherein the follow-up survey includes one or more questions that can be scored by the mentor and the protégé.

9. The method of claim 8, further comprising generating at least one report based at least partially on the first termination survey, the second termination survey, and the follow-up survey.

10. The method of claim 9, wherein the at least one report comprises a tally report, a detail report, or a follow-up survey report.

11. The method of claim 10, wherein the tally report includes a number of protégé applications submitted within a date range, a number of mentor applications submitted within a date range, a number of mentoring relationships formed within a date range, a number of terminated mentoring relationships within a date range, a number of “natural end” terminated mentoring relationships within a date range, a number of “early terminated” mentoring relationships within a date range, a number of declined protégés within a date range, a total number of established mentoring relationships, a total number of available mentors, a total number of pending protégés, a total number of mentoring tool users, and a total number of site visitors.

12. The method of claim 10, wherein the detail report includes a list of mentors by name, a list of protégés by name, and a list of mentoring relationships.

13. The method of claim 10, wherein the follow-up survey report includes an average score received for each of the one or more questions, a total number of surveys received, at least one comment, and a source of the comment.

14. The method of claim 9, further comprising selectively modifying a management process in connection with establishment of a future mentoring relationship based at least partially on the at least one report.

15. The method of claim 14, wherein the matching mentor application is matched with the matching protégé application based on a first set of criteria.

16. The method of claim 15, wherein the first criteria of criteria includes at least one of the following: building a team, communicating persuasively, taking a risk, driving change, achieving results through others, and accomplishing results.

17. The method of claim 16, wherein the matching mentor application is matched with the matching protégé application based on a second set of criteria.

18. The method of claim 17, wherein the second set of criteria includes at least one of the following: experience, location, title, and department.

19. The method of claim 1, further comprising contacting a protégé associated with a matching protégé application after a match is determined.

20. The method of claim 19, further comprising querying the protégé as to whether the protégé would like to initiate contact with a mentor associated with a matching mentor application.

21. The method of claim 20, further comprising contacting a mentor associated with a matching mentor application to determine whether the mentor is willing to form the mentoring relationship with the protégé.

22. A system for managing mentoring relationships, the system comprising:
a network;
at least one mentor computer coupled to the network;
at least one protégé computer coupled to the network; and
at least one mentoring relationship management server coupled to the network, the mentoring relationship management server including a reporting module, a mentor-protégé matching module, and a mentoring relationship termination module.

23. The system of claim 22, wherein the mentor-protégé matching module includes a computer program embedded within the mentor-protégé matching module, the computer program comprising:
instructions to receive a plurality of mentor applications;
instructions to receive a plurality of protégé applications; and
instructions to match one of the plurality of mentor applications with one of the plurality of protégé applications to create a mentoring relationship.

24. The system of claim 23, wherein the mentoring relationship termination module comprises instructions to receive an indication to terminate the mentoring relationship.

25. The system of claim 24, wherein the mentoring relationship termination module further comprises instructions to generate a first termination survey for a mentor associated with a matching mentor application.

26. The system of claim 25, wherein the mentoring relationship termination module further comprises instructions to generate a second termination survey for a protégé associated with a matching protégé application.

27. The system of claim 26, wherein the mentoring relationship termination module further comprises instructions to communicate the first termination survey to the mentor.

28. The system of claim 26, wherein the mentoring relationship termination module further comprises instructions to communicate the second termination survey to the mentor.

29. The system of claim 28, wherein the reporting module comprises instructions to generate at least one mentoring relationship report based at least partially on a completed first termination survey and a completed second termination survey.
